(19) United States
(12) Patent Application Publication
(10) Pub. No.: US 2020/0188771 A1
(43) Pub. Date: Jun. 18, 2020

(54) CONVEYOR DEVICE

(71) Applicant: KONAMI AMUSEMENT CO., LTD., Ichinomiya-shi (JP)

(72) Inventors: Ken SASAKI, Ichinomiya-shi (JP); Kenji GENNOZONO, Ichinomiya-shi (JP); Takahiro YOSHINO, Ichinomiya-shi (JP); Hitoshi ARISAWA, Ichinomiya-shi (JP); Etsushi TAKAHASHI, Ichinomiya-shi (JP)

(73) Assignee: KONAMI AMUSEMENT CO., LTD., Ichinomiya-shi (JP)

(21) Appl. No.: 16/801,881

(22) Filed: Feb. 26, 2020

Related U.S. Application Data
(63) Continuation of application No. PCT/JP2018/032156, filed on Aug. 30, 2018.

(30) Foreign Application Priority Data
Aug. 31, 2017 (JP) 2017-167832
Aug. 31, 2017 (JP) 2017-167833
Aug. 31, 2017 (JP) 2017-167834
Aug. 31, 2017 (JP) 2017-167836
Aug. 31, 2017 (JP) 2017-167837

(51) Int. Cl. A63F 3/00; B65G 33/14; B65G 11/02; G07F 1/02; G07F 5/00; B65G 53/06

(52) U.S. Cl. CPC A63F 3/00895; B65G 33/14; B65G 11/026; A63F 2003/00899; G07F 5/00; B65G 53/06; G07F 1/02

(57) ABSTRACT

A conveyor device includes a supporter extending from a first end of a rotation axis to a second end thereof in a helical manner relative to the rotation axis, an encircling member that encircles at least a third portion of the supporter, the third portion being a portion between a first portion on the first end and a second portion on the second end, and at least one guide for a three-dimensional game object to move from the first end to the second end along with rotation of the supporter, the at least one guide extending from the first end to the second end within a gap between the supporter and the encircling member and being configured such that the guide in coordination with the supporter and the encircling member supports the three-dimensional game object when the three-dimensional game object moves from the first end to the second end.

### CROSS REFERENCE TO RELATED APPLICATIONS

This Application is a Continuation Application of PCT Application No. PCT/JP2018/032156, filed Aug. 30, 2018, which is based on and claims priority from Japanese Patent Application No. 2017-167832, filed Aug. 31, 2017, Japanese Patent Application No. 2017-167833, filed Aug. 31, 2017, Japanese Patent Application No. 2017-167834, filed Aug. 31, 2017, Japanese Patent Application No. 2017-167836, filed Aug. 31, 2017, and Japanese Patent Application No. 2017-167837, filed Aug. 31, 2017, the entire contents of which are incorporated herein by reference.

### BACKGROUND OF THE INVENTION

### Field of the Invention

The present invention relates to a conveyor device.

### Description of Related Art

There has been conventionally proposed in the art pusher game apparatuses in which disk-shaped token coins (medals) fed into a game field are moved, as is disclosed, for example, in Japanese Patent Application Laid-Open Publication No. 2013-99632. A lift hopper or the like that moves the token coins along a rail is used in a conventional pusher game apparatus to transport the token coins to a feeding portion.

In addition, three-dimensional game objects such as spherical objects can be used instead of token coins in a pusher game. Assumed is use of game objects (for example, spherical game objects) that are rollable regardless of orientation of the game objects instead of use of token coins as used in the conventional pusher game apparatus. In a configuration in which three-dimensional game objects are used, the need arises for a mechanism suitable for transporting the three-dimensional game objects in place of a lift hopper used to transport token coins.

The present invention has been achieved in view of circumstances described above and an object of the present invention is to provide a technique that is able to suppress increase in a number of guides that guide movement of three-dimensional game objects in a conveyor device, in which the conveyor device transports the three-dimensional game objects from one end of a rotation axis to the other end thereof along with rotation of a supporter extending in a helical manner from one end to the other end of the rotation axis.

### SUMMARY OF THE INVENTION

A game apparatus according to an aspect of the present invention includes: a supporter configured to support a three-dimensional game object, in which the supporter is rotatable about a rotation axis having a first end and a second end, with the supporter extending from the first end to the second end in a helical manner relative to the rotation axis, and in which the supporter includes a first portion on the first end of the rotation axis, a second portion on the second end, and a third portion between the first portion and the second portion; an encircling member that encircles at least the third portion of the supporter; and at least one guide for the three-dimensional game object to move from the first end to the second end along with the rotation of the supporter, in which the at least one guide is configured such that the guide in coordination with the supporter and the encircling member supports the three-dimensional game object when the three-dimensional game object moves from the first end to the second end, and in which the at least one guide extends from the first end to the second end within a gap between the supporter and the encircling member.

### BRIEF DESCRIPTION OF THE DRAWINGS

FIG. 1 is an external view illustrating an example of a game apparatus 10 according to an embodiment of the present invention;

FIG. 2 is a diagram illustrating the game apparatus 10 when viewed in a Z-axis direction shown in FIG. 1;

FIG. 3 is a diagram illustrating an example of a control panel 160a;

FIG. 4 is a diagram illustrating an example of a game field 110a;

FIG. 5 is a diagram illustrating the game field on which small balls M1 and large balls M2 are spread all over the game field 110a;

FIG. 6 is a diagram illustrating an example of a ball number lottery portion 120a;

FIG. 7 is a diagram illustrating an example of a marble chance execution portion 130a;

FIG. 8 is a diagram illustrating an example of a marble jackpot (JP) chance execution portion 140a;

FIG. 9 is an explanatory diagram of a flow of small balls M1 and large balls M2;

FIG. 10 is a diagram illustrating a flow of small balls M1 in relation to a screw lifter 170a;

FIG. 11 is a diagram illustrating an example of a path 310a and a first hopper 230a;

FIG. 12 is a diagram illustrating an example of a path 320a, a second hopper 240a, and a third hopper 250a;

FIG. 13 is a diagram illustrating an example of paths 330a,340a and a count hopper 220a;

FIG. 14 is a diagram illustrating an example of the screw lifter 170a;

FIG. 15 is a diagram illustrating the screw lifter 170a, in which view an encircling member 1750 is not shown;

FIG. 16 is a diagram illustrating the screw lifter 170a, in which view the encircling member 1750 and guides 1760 are not shown;

FIG. 17 is a perspective view mainly illustrating a take-in portion 1710;

FIG. 18 is a diagram illustrating an example of the take-in portion 1710 and the path 340a;

FIG. 19 is a perspective view mainly illustrating a discharger 1720;

FIG. 20 is a diagram illustrating an example of a ceiling housing portion 290a;

FIG. 21 is a sectional view along a ling E-E in FIG. 20;

FIG. 22 is a sectional view along a line F-F in FIG. 20 when a face 4021 is changed to be at an angle that allows small balls M1 to roll to a supply path 460;

FIG. 23 is a diagram illustrating an example of the first hopper 230a;

FIG. 24 is a sectional view along a line G-G in FIG. 23;

FIG. 25 is a diagram illustrating an example in which ceiling housing portions 290a of two game apparatuses 10 are coupled to each other;

FIG. 26 is a sectional view along a line H-H in FIG. 25;

FIG. 27 is a diagram illustrating an example in a case in which the supply destination of small balls M1 is set to a supply path 460 of one of game apparatuses 10;

FIG. 28 is a sectional view along a line I-I in FIG. 27;

FIG. 29 is a diagram illustrating an example in a case in which the supply destination of small balls M1 is set to a supply path 460 of the other game apparatus 10 in a first modification; and

FIG. 30 is a sectional view along a line J-J in FIG. 29.

### DESCRIPTION OF THE EMBODIMENTS

Embodiments of the present invention are explained below with reference to the drawings. In the drawings, the dimensions and scales of elements may be different from those of actual configurations as appropriate. The embodiments described below are preferred specific examples of the invention. Therefore, various technically preferable limitations are included in the embodiments. However, the scope of the present invention is not limited to the embodiments unless otherwise described to specifically limit the present invention.

### A. Embodiment

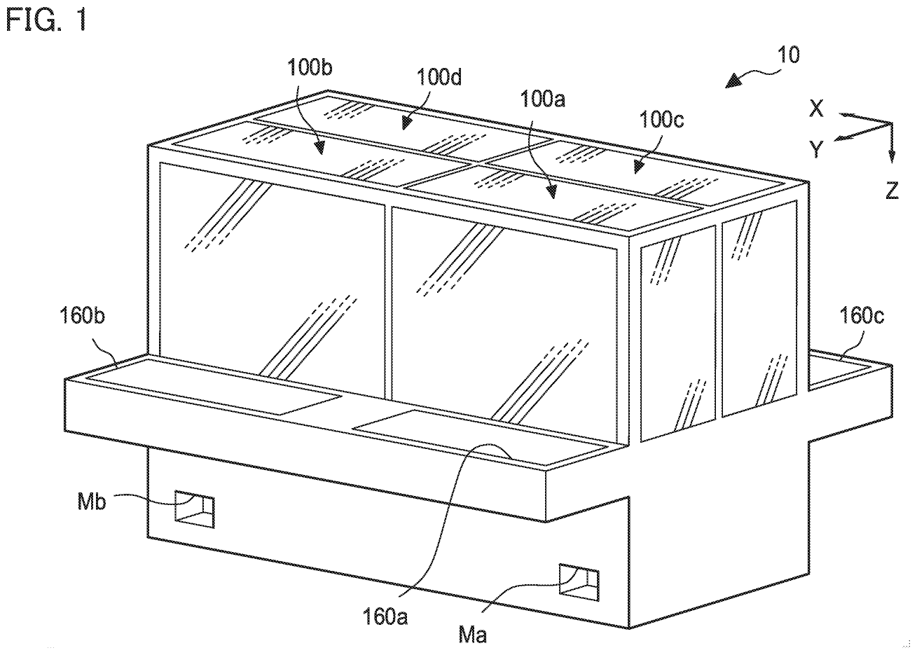

FIG. 1 is an external view illustrating an example of a game apparatus 10 according to the present embodiment.

### 1. Overview of Game Apparatus

The game apparatus 10 is installed in an entertainment facility (for example, a video arcade or a casino) or is installed in a retail facility (for example, a shopping mall). The game apparatus 10 is also referred to as a gaining machine when used in a casino. The game apparatus 1 does not need to be a business-use device installed in stores and may be, for example, a home-use game device or a mobile terminal device.

The game apparatus 10 is configured such that a game can be played using game currency such as token coins (also referred to as “medals”), credits, or points. The game currency such as token coins, credits, points, or the like may be exchangeable or may not be exchangeable for real currency. The game apparatus 10 may be configured such that real currency may be used to play a game.

Elements (hereinafter, also referred to as “play price elements”) that the game apparatus 10 receives from a player to play a game may be of the same type as elements (hereinafter, also referred to as “reward elements”) that are used in the game apparatus 10 as a reward to the player. For example, the play price elements and the reward elements may both be token coins. Alternatively, the play price elements and the reward elements may be of different types. For example, the play price elements may be token coins, and the reward elements may be vouchers.

The game apparatus 10 includes stations 100a, 100b, 100c, and 100d. The number of stations included in the game apparatus 10 is not limited to “four” and may be any number “equal to or greater than one”. A same type of game can be independently performed at the respective stations 100a, 100b, 100c, and 100d. In the present embodiment, the type of game performed in the respective stations 100a, 100b, 100c, and 100d is a game that progresses in accordance with movement of game objects (hereinafter, also referred to as “three-dimensional game objects”) that are rollable regardless of orientation of the game objects. Accordingly, each of the stations 100a, 100b, 100c, and 100d also functions as a game apparatus. Each of the stations 100a, 100b, 100c, and 100d is also an example of a unit portion. Furthermore, the stations 100a, 100b, 100c, and 100d are examples of unit portions in which respective players can play games.

The three-dimensional game objects may be spherical objects (for example, marbles) or may be substantially spherical objects (for example, polyhedrons). In the present embodiment, two types of marbles having different sizes are used as the three-dimensional game objects. Hereafter, smaller ones of the two types of marbles having different sizes are referred to as “small balls” and larger ones are referred to as “large balls”.

The stations 100a, 100b, 100c, and 100d have the same configuration. Therefore, the station 100a is primarily explained below to avoid redundancy, and the stations 100b, 100c, and 100d are explained as necessary.

A suffix “a” is appended to signs of components of the station 100a. Components of the stations 100b, 100c, and 100d are explained by replacement of the suffix “a” of the components of the station 100a with “b”, “c”, and “d”, respectively.

The game apparatus 10 includes components (hereafter, also referred to as “shared components”) that are shared by a plurality of stations. Among the shared components, components shared by the station 100a are explained as components of the station 100a. Components not used by the station 100a and used by the station 100b among the shared components are explained as components of the station 100b. Components used by neither the station 100a nor 100b but used by the station 100c among the shared components are explained as components of the station 100c.

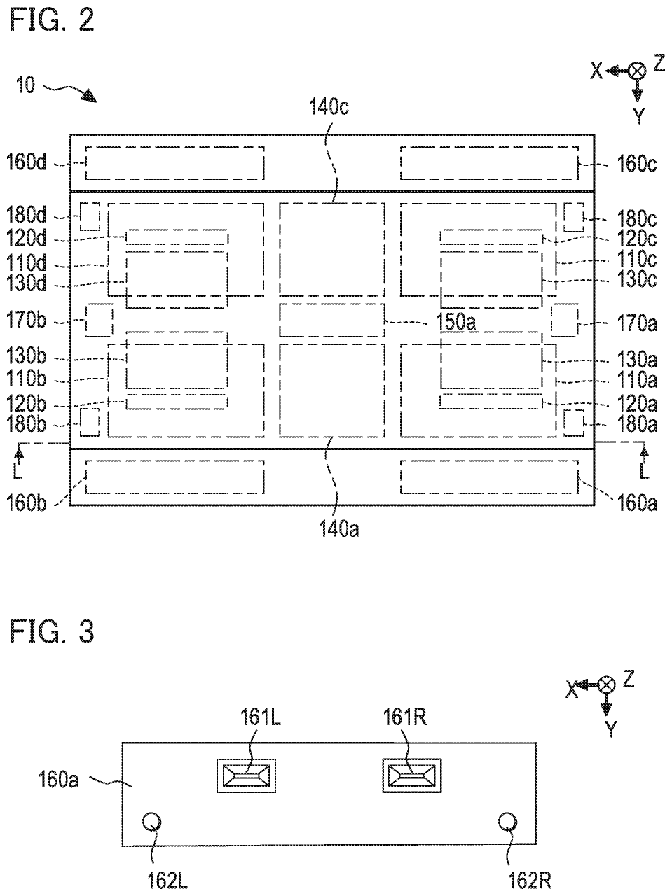

FIG. 2 is a diagram illustrating a positional relationship of different components of the game apparatus 10 when viewed in a Z-axis direction shown in FIG. 1. The station 100a includes a game field 110a, a ball number lottery portion 120a, a marble chance execution portion 130a, a marble-JP (jackpot) chance execution portion 140a, a JP payout portion 150a, a control panel 160a, a screw lifter 170a, and an air lifter 180a. The station 100a further includes a payout port Ma as shown in FIG. 1.

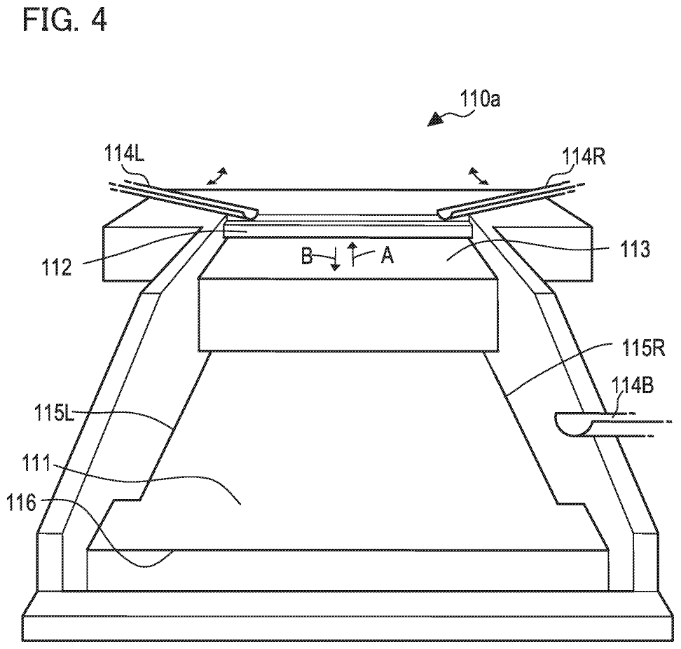

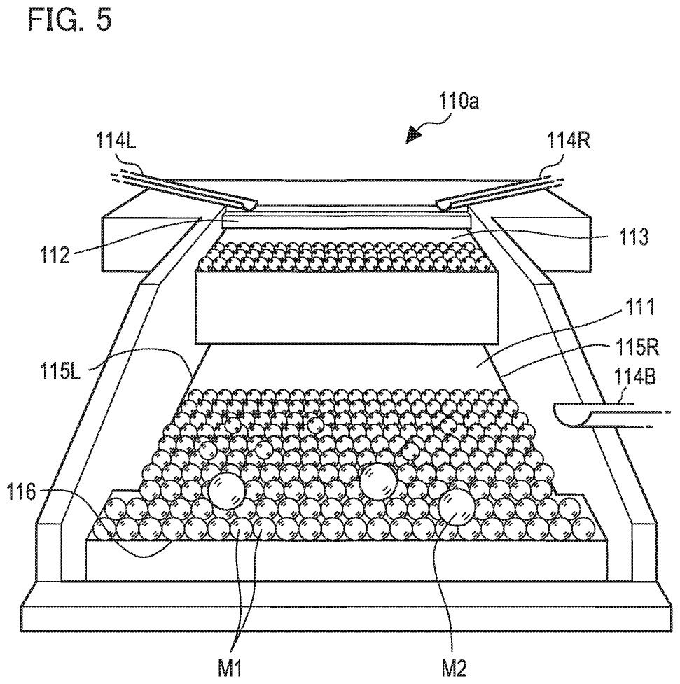

In the game field 110a, a pusher game in which small balls M1 and large balls M2 are used is performed as an example of the game that progresses according to movement of the three-dimensional game objects (see FIGS. 4 and 5, which will be explained later). In the pusher game, a player of the station 100a (hereafter, simply referred to as “player”) operates the control panel 160a so that small balls M1 are fed onto the game field 110a in which small balls M1 and large balls M2 are present. In the game field 110a, the small balls M1 and the large balls M2 are pushed as a pusher table 113 reciprocates. In response to the pushing, small balls M1 and large balls M2 located on a front edge 116 of a lower table 111 fall from the lower table 111.

The station 100a provides the player with a reward depending on the number of small balls M1 that have fallen from the game field 110a. The reward may be game credits, token coins, points, vouchers, real money, or tickets. In the present embodiment, token coins are provided as the reward. The token coins are paid out from the payout port Ma.

The ball number lottery portion 120a is an example of a lottery portion. In the ball number lottery portion 120a, a first lottery using a small ball M1 is performed each time a first condition is met in the game field 110a. Such condition is, for example, a condition in which “in large balls M2 have fallen from the game field 110a, where in is an integer equal to or greater than one)”. A case in which in =1 is explained below. In the present embodiment, the ball number lottery portion 120a executes a lottery for determining the number of small balls M1, as the first lottery.

The marble chance execution portion 130a is another example of the lottery portion. In the marble chance execution portion 130a, a second lottery using small balls M1 is performed each time a second condition is met in the game field 110a. Such condition is, for example, a condition in which “n large balls M2 have fallen from the game field 110a, where n is an integer equal to or greater than m”. A case in which n=3 is explained below. The first lottery is performed three times before the second lottery is performed, so the number of small balls M1 used in the second lottery is the total number of balls obtained over three lotteries, which is the sum of the results thereof. In the present embodiment, the marble chance execution portion 130a performs as the second lottery a lottery for determining whether to operate the marble-JP chance execution portion 140a. Hereinafter, the second lottery is referred to also as “marble chance”.

The marble-JP chance execution portion 140a is shared by the stations 100a and 100b. In the marble-JP chance execution portion 140a, a third lottery using small balls M1 is performed when it is determined by the lottery in the marble chance execution portion 130a that the marble-JP chance execution portion 140a is to be operated. In the present embodiment, the marble-JP chance execution portion 140a performs as the third lottery a lottery for determining whether the JP payout portion 150a performs payout of many small balls M1 (hereinafter, also referred to as “marble JP”) as a bonus onto the game field 110a. The third lottery is also referred to as “marble-JP chance” below.

Furthermore, the marble-JP chance execution portion 140a performs a lottery for determining whether the JP payout portion 150a performs payout of a marble JP with respect to a game field 110b, when it is determined by a lottery in a marble chance execution portion 130b in the station 100b that the marble-JP chance execution portion 140a is to be operated.

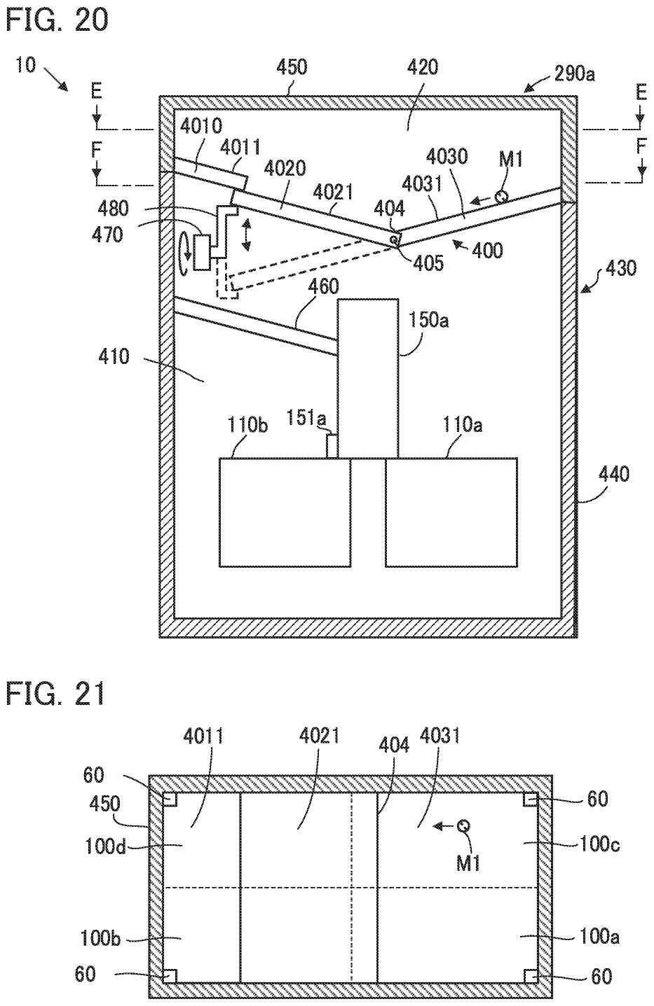

The JP payout portion 150a is shared by the stations 100a, 100b, 100c, and 100d. The JP payout portion 150a is placed so as to be positioned at the center of the game apparatus 10 when the game apparatus 10 is viewed as a plane as shown in FIG. 2. The JP payout portion 150a has a path switcher 151a that selectively switches the payout destination of small balls M1 to one of the game fields 110a, 110b, 110c, and 110d (see FIGS. 20, 25, 27, and 29, which will be explained later).

The JP payout portion 150a performs a marble JP with respect to the game field 110a and pays out (discharges) small balls M1 to the game field 110a when it is determined by the lottery in the marble-JP chance execution portion 140a that a marble JP is to be paid out to the game field 110a.

The JP payout portion 150a performs payout of a marble JP to the game field 110b when it is determined by the lottery in the marble-JP chance execution portion 140a that a marble JP is to be paid out to the game field 110b. Similarly, the JP payout portion 150a performs payout of a marble JP to the game field 110c when it is determined by a lottery in the marble-JP chance execution portion 140c that payout of a marble JP to the game field 110c is to be performed. Furthermore, the JP payout portion 150a pays out a marble JP to the game field 110d when it is determined by the lottery in the marble-JP chance execution portion 140c that payout of a marble JP to the game field 110d is to be performed.

Referring back to FIG. 2, the control panel 160a receives operations of the player. FIG. 3 is a diagram illustrating an example of the control panel 160a. The control panel 160a includes slots 161L and 161R and feeding-direction changing buttons 162L and 162R.

Token coins are inserted into the slots 161L and 161R. When a token coin is inserted into the slot 161L, a small ball M1 is fed onto the game field 110a from a feeding portion (a feeding portion 114L shown in FIGS. 4 and 5) on the left side of the game field 110a. The feeding-direction changing button 162L is used to change the feeding direction of the small ball M1 from the feeding portion 114L. When a token coin is inserted into the slot 161R, a small ball M1 is fed onto the game field 110a from a feeding portion (a feeding portion 114R shown in FIGS. 4 and 5) on the right side of the game field 110a. The feeding-direction changing button 162R is used to change the feeding direction of the small ball M1 from the feeding portion 114R.

Referring back to FIG. 2, the screw lifter 170a is shared by the stations 100a and 100c. The screw lifter 170a lifts, for example, small balls M1 that have fallen from the game field 110a and small balls M1 that have fallen from the game field 110c to a higher position than the game fields 110a and 110c. The small balls M1 lifted by the screw lifter 170a are, for example, used in the game field 110a, are used in the marble chance execution portion 130a, are used in the station 100b adjacent to the station 100a, are used in the game field 110c, are used in a marble chance execution portion 130c, or are used in the station 100d adjacent to the station 100c.

The air lifter 180a lifts small balls M1 by sending air from a fan into a tube to which the small balls M1 have been transported. The inside diameter of the tube is larger than the diameter of the small balls M1 and is desirably, for example, smaller than a size of 1.5 times as large as the diameter of the small balls M1. As a value (hereinafter, also referred to as “diameter difference”), which is obtained by subtracting the diameter of the small balls M1 from the inside diameter of the tube approaches “0”, the force of air from the fan is more likely to be transmitted to the small balls M1 in the tube, whereby the small balls M1 can be lifted in a shorter time. Accordingly, the diameter difference is preferably close to “0”. Furthermore, when the diameter difference is close to “0”, the outside diameter of the tube can be reduced and the air lifter 180a can be reduced in size. In the present embodiment, the air lifter 180a lifts small balls M1 vertically. It is to be noted that the direction in which the air lifter 180a lifts small balls M1 may deviate from the vertical. The small balls M1 lifted by the air lifter 180a are used in the marble-JP chance execution portion 140a or are used in the JP payout portion 150a via a ceiling housing portion 290a (see FIG. 20), which will be explained later.

### 2. Game Field

FIG. 4 is a diagram illustrating an example of the game field 110a. FIG. 5 is a diagram illustrating the game field 110a on which small balls M1 and large balls M2 are spread all over the game field 110a. The game field 110a includes the lower table 111, a wall portion 112, the pusher table 113, the feeding portions 114L and 114R, a feeding portion 114B, cutouts 115L and 115R, and the front edge 116.

The lower table 111 and the wall portion 112 are fixed. The cutout 115L is located on the left end of the lower table 111, and the cutout 115R is located on the right end thereof. The cutouts 115L and 115R each have a shape that allows passage of small balls M1 and that does not allow passage of large balls M2.

The pusher table 113 reciprocates in front and back directions (in directions of arrows A and B in FIG. 4) through a space formed between the lower edge of the wall portion 112 and the top surface of the lower table 111 in accordance with to an operation of a driving mechanism (not shown).

The feeding portion 114L feeds a small ball M1 onto the pusher table 113 from the left side of the game field 110a. The feeding portion 114R feeds a small ball M1 onto the pusher table 113 from the right side of the game field 110a. The feeding portion 114B feeds a large ball M2 onto the lower table 111.

For example, when the feeding portion 114L or 114R feeds a small ball M1 onto the pusher table 113 (see FIG. 5) on which small balls M1 are spread all over, and then the pusher table 113 moves in the direction of the arrow A shown in FIG. 4, the small balls M1 on the pusher table 113 are pushed by the wall portion 112 and move in the direction of the arrow B shown in FIG. 4. Accordingly, small balls M1 located on the opposite side to the wall portion 112 on the pusher table 113 fall onto the lower table 111.

When the pusher table 113 then moves in the direction of the arrow B, small balls M1 and large balls M2 on the lower table 111 are pushed by the pusher table 113. Accordingly, small balls M1 located on ends of the lower table 111 fall from the front edge 116 or the cutout 115L or 115R. Large balls M2 located on the front edge 116 fall from the front edge 116.

Small balls M1 that have fallen from the front edge 116 are allocated to a reward. Meanwhile, small balls M1 that have fallen from the cutout 115L and small balls M1 that have fallen from the cutout 115R are handled as so-called “fall from side walls (out-zone)” and are not allocated to a reward. Each time a large ball M2 falls from the front edge 116, the ball number lottery portion 120a operates.

### 3. Ball Number Lottery Portion

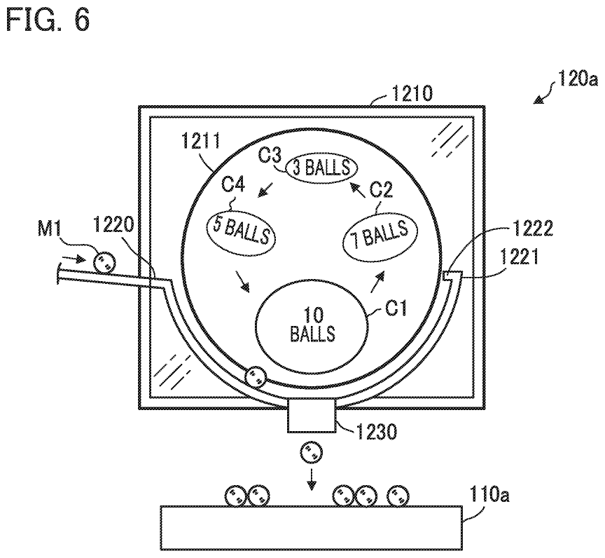

FIG. 6 is a diagram illustrating an example of the ball number lottery portion 120a. The ball number lottery portion 120a includes a display 1210, a passage 1220, and a discharger 1230.

The display 1210 includes a circular screen 1211. The display 1210 displays candidates C1 to C4 for the number of small balls M1 on the screen 1211. In FIG. 6, the candidate C1 indicates “ten balls,” the candidate C2 indicates “seven balls,” the candidate C3 indicates “three balls,” and the candidate C4 indicates “five balls.” The number of candidates displayed on the screen 1211 is not limited to “4” and can be appropriately changed. The numbers respectively indicated by the candidates are not limited to “ten balls,” “seven balls,” “three balls,” and “five balls” and can be appropriately changed.

A small ball M1 is fed to the passage 1220. The small ball M1 fed to the passage 1220 passes the passage 1220. A part of the passage 1220 is located along a part of the outer circumference of the screen 1211. A protrusion 1222 for preventing the small ball M1 from jumping out of the passage 1220 is provided at an end 1221 of the passage 1220.

Each time a large ball M2 falls from the front edge 116 (see FIG. 5), the display 1210 displays the candidates C1 to C4 on the screen 1211 and a small ball M1 is fed to the passage 1220. The display 1210 changes the display positions of the candidates C1 to C4 on the screen 1211 as time elapses. At a point in time when the small ball M1 fed to the passage 1220 thereafter moves along the part of the outer circumference of the screen 1211 and passes the discharger 1230 having a discharging hole, the movement of the candidates C1 to C4 on the screen 1211 stops. The number of balls indicated by a candidate that is closest to the discharger 1230 among the candidates C1 to C4 is then determined. It is to be noted that the small ball M1 having passed the discharger 1230 falls on the game field 110a (the pusher table 113, for example).

### 4. Marble Chance Execution Portion

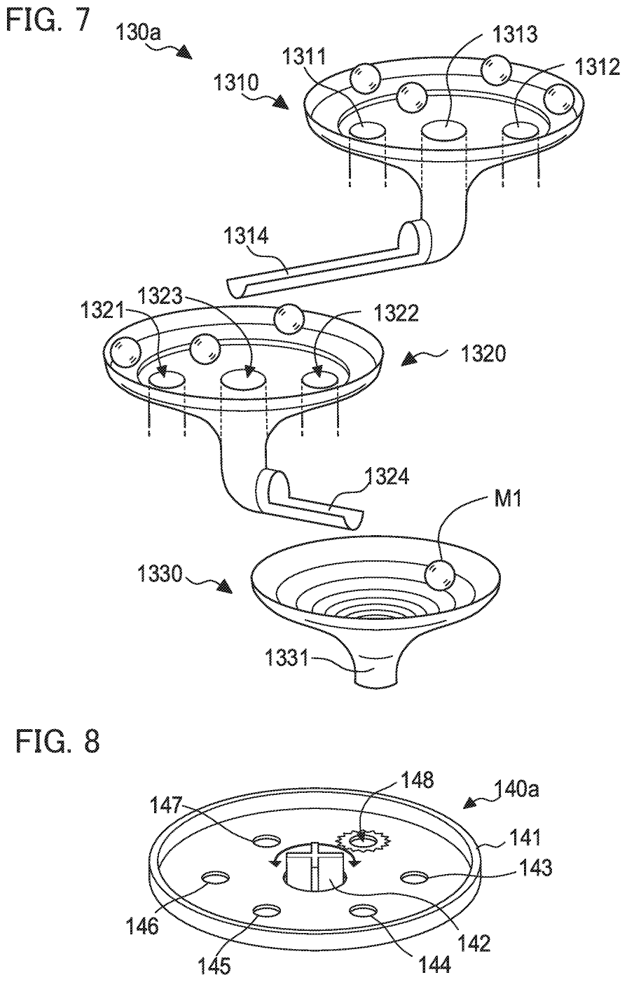

FIG. 7 is a diagram illustrating an example of the marble chance execution portion 130a. The marble chance execution portion 130a includes a first distributer 1310, a second distributer 1320, and an accessory 1330.

When three large balls M2 fall from the front edge 116, small balls M1 are fed to the first distributer 1310 each time one of the three large balls M2 falls. The number of small balls M1 fed each time is the sum of the numbers of small balls M1 determined in the first lottery.

The small balls M1 fed to the first distributer 1310 enter one of holes 1311, 1312, and 1313 provided on the first distributer 1310. Small balls M1 having entered the hole 1311 or 1312 are collected without being fed to the second distributer 1320. Meanwhile, small balls M1 having entered the hole 1313 are fed to the second distributer 1320 through a passage 1314.

The small balls M1 fed to the second distributer 1320 enter one of holes 1321, 1322, and 1323 provided on the second distributer 1320. Small balls M1 having entered the hole 1321 or 1322 are collected without being fed to the accessory 1330. Meanwhile, small balls M1 having entered the hole 1323 are fed to the accessory 1330 through a passage 1324.

The small balls M1 fed to the accessory 1330 are discharged from a discharger 1331 provided on the accessory 1330. When the small balls M1 are discharged from the discharger 1331, the marble-JP chance execution portion 140a operates.

### 5. Marble-JP Chance Execution Portion

FIG. 8 is a diagram illustrating an example of the marble-JP chance execution portion 140a. The marble-JP chance execution portion 140a includes a distributer 141 and a small ball mover 142. When the marble-JP chance execution portion 140a operates, a small ball M1 is fed to the distributer 141. On the distributer 141, each time a small ball M1 is brought into contact with the small ball mover 142 that rotates in both directions, the small ball M1 is subject to an external force from the small ball mover 142 and is moved toward the outer circumference of the distributer 141. As the above state is repeated, the small ball M1 enters one of holes 143 to 148 provided on the distributer 141. When the small ball M1 enters one of the holes 143 to 147, a marble JP is not paid out. On the other hand, when the small ball M1 enters the hole 148, payout of a marble JP is carried out.

### 6. Flow of Small Balls M1 and Large Balls M2

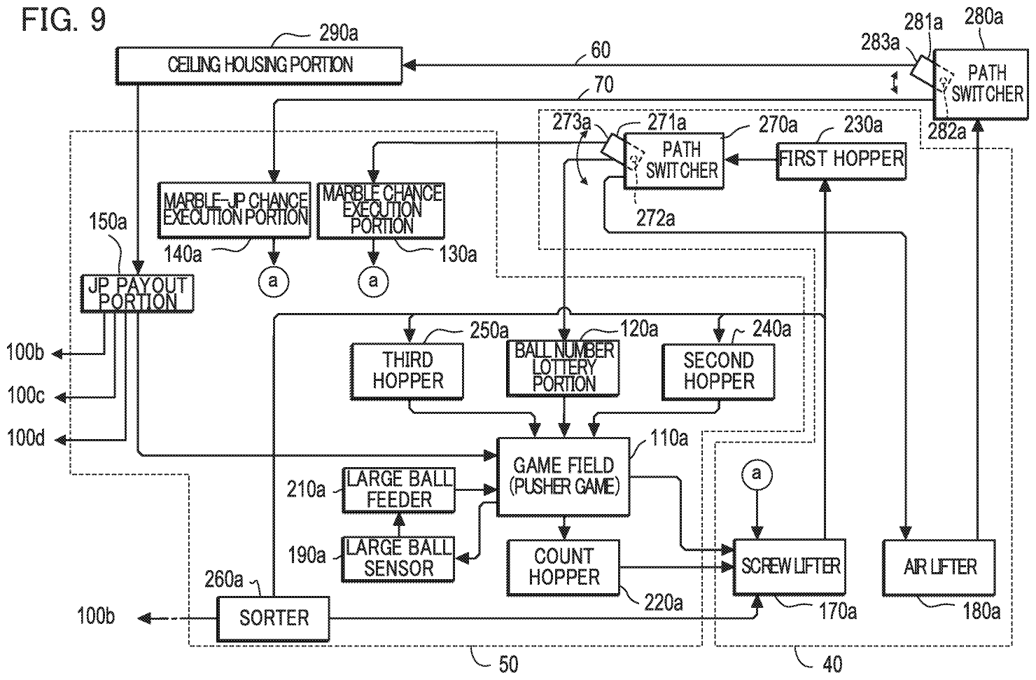

FIG. 9 is an explanatory diagram of a flow of small balls M1 and large balls M2 in the station 100a. As shown in FIG. 9, the station 100a includes a large ball sensor 190a, a large-ball feeding portion 210a, a count hopper 220a, a first hopper 230a, a second hopper 240a, a third hopper 250a, a sorter 260a, path switchers 270a and 280a, the ceiling housing portion 290a, a first path 60, and a second path 70, in addition to the configuration shown in FIG. 2.

The screw lifter 170a, the first hopper 230a, the path switcher 270a, and the air lifter 180a are included in a game object conveyor 40. The game object conveyor 40 transports small balls M1 located in a game field space by selectively using the first path 60 and the second path 70. The first path 60 is at an angle that allows small balls M1 to roll toward the ceiling housing portion 290a. The second path 70 is at an angle that allows small balls M1 to roll toward the marble-JP chance execution portion 140a. The first path 60 and the second path 70 are examples of a predetermined transport path. The game object conveyor 40 can transport both small balls M1 that are to be transported to the first path 60 and small balls M1 that are to be transported to the second path 70. Therefore, the configuration can be simplified as compared to a case in which small balls M1 that are to be transported to the first path 60 and small balls M1 that are to be transported to the second path 70 are transported by different conveyors.

The game field space is located below the ceiling housing portion 290a. The game field space includes the game field 110a, the ball number lottery portion 120a, the marble chance execution portion 130a, the marble-JP chance execution portion 140a, the JP payout portion 150a, and the like.

The game field 110a, the ball number lottery portion 120a, the marble chance execution portion 130a, the marble-JP chance execution portion 140a, the JP payout portion 150a, the large ball sensor 190a, the large-ball feeding portion 210a, the count hopper 220a, the second hopper 240a, the third hopper 250a, and the sorter 260a are included in a game execution portion 50. The game execution portion 50 executes, for example, a game (a pusher game in the present embodiment) in which small balls M1 are used and which is performed in the game field space.

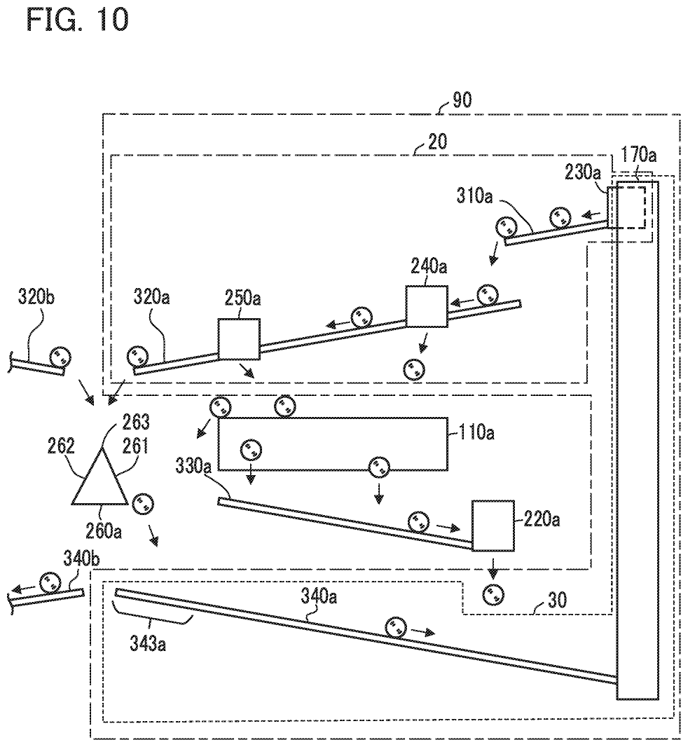

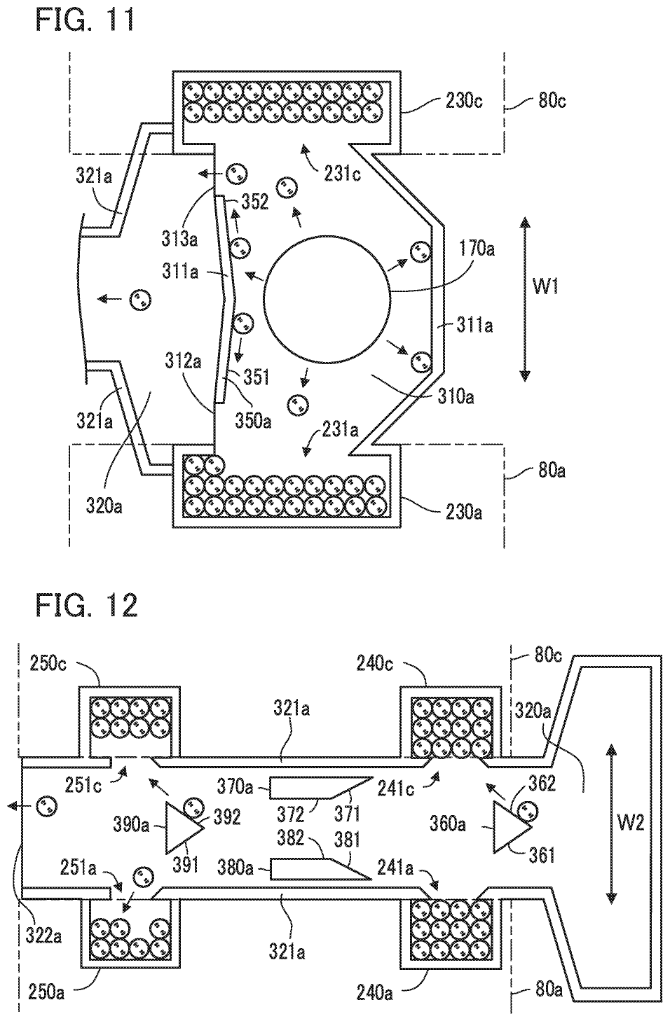

The configuration of the station 100a except for the screw lifter 170a, the ceiling housing portion 290a, and paths 310a, 320a, 330a, and 340a constitutes a game unit portion 80a (for the game unit portion 80a, see FIGS. 11, 12, and 13, which will be explained later). The paths 310a, 320a, 330a, and 340a (see FIG. 10) will be explained later.

The large ball sensor 190a and the large-ball feeding portion 210a are explained first. The large ball sensor 190a detects a large ball M2 that has fallen from the front edge 116. The ball number lottery portion 120a and the marble chance execution portion 130a operate based on a result of the detection by the large ball sensor 190a. The large-ball feeding portion 210a feeds a large ball M2 onto the lower table 111.

The game field 110a, the count hopper 220a, the screw lifter 170a, the first hopper 230a, the second hopper 240a, the third hopper 250a, the sorter 260a, and the path switcher 270a are explained next.

Small balls M1 that have fallen from the front edge 116 of the game field 110a enter the count hopper 220a. The count hopper 220a houses the small balls M1 that have entered and counts the housed small balls M1. The count value is used to calculate a reward for the player. The count hopper 220a discharges the counted small balls M1.

The screw lifter 170a lifts the small balls M1 discharged from the count hopper 220a, small balls M1 that have fallen from the cutout 115L, small balls M1 that have fallen from the cutout 115R, small balls M1 used in the marble chance execution portion 130a, small balls M1 used in the marble-JP chance execution portion 140a, and small balls M1 sorted by the sorter 260a into the station 100a in a manner described below.

Small balls M1 lifted by the screw lifter 170a can enter the first hopper 230a. The first hopper 230a houses and uses the small balls M1 that have entered. In the present embodiment, the first hopper 230a uses the housed small balls M1 by, via the path switcher 270a, feeding the balls to the ball number lottery portion 120a, feeding the balls to the marble chance execution portion 130a, or supplying the balls to the air lifter 180a. The first hopper 230a is an example of a first utilizer.

Small balls M1 not having entered the first hopper 230a among the small balls M1 lifted by the screw lifter 170a can enter the second hopper 240a. The second hopper 240a houses and uses small balls M1 that have entered. In the present embodiment, the second hopper 240a uses the housed small balls M1 by feeding them onto the game field 110a (specifically, the pusher table 113) from the feeding portion 114R. The second hopper 240a is another example of the first utilizer and is an example of a second utilizer. The second hopper 240a is also an example of a game object utilizer.

Small balls M1 that have entered neither the first hopper 230a nor the second hopper 240a among the small balls M1 lifted by the screw lifter 170a can enter the third hopper 250a. The third hopper 250a houses and uses the small balls M1 having entered. In the present embodiment, the third hopper 250a uses the housed small balls M1 to be fed to the game field 110a (specifically, the pusher table 113) from the feeding portion 114L. The third hopper 250a is another example of the second utilizer. The third hopper 250a is also another example of the game object utilizer.

Among the small balls M1 lifted by the screw lifter 170a, some small balls M1 do not enter any of the first hopper 230a, the second hopper 240a, and the third hopper 250a. The sorter 260a sorts those small balls M1 into either the station 100a (the game unit portion 80a) or the station 100b (a game unit portion 80b).

The path switcher 270a switches the path of a small ball M1 discharged from the first hopper 230a, selectively to one of a path toward the ball number lottery portion 120a, a path toward the marble chance execution portion 130a, and a path toward the air lifter 180a. In the present embodiment, the path switcher 270a has a discharger 271a configured to receive the small ball M1 discharged from the first hopper 230a and discharge the received small ball M1. The discharger 271a is fixed to a rotation shaft 272a that is rotated by a driver such as a motor (not shown). The path switcher 270a selectively switches the path for passage of the small ball M1 to one of the path toward the ball number lottery portion 120a, the path toward the marble chance execution portion 130a, and the path toward the air lifter 180a. Specifically, the path switcher 270a selectively switches the position of a discharge port 273a for a small ball M1 to one of a position above the path toward the ball number lottery portion 120a, a position above the path to the marble chance execution portion 130a, and a position above the path to the air lifter 180a. The discharge port 273a is provided on the discharger 271a.

The air lifter 180a, the path switcher 280a, and the ceiling housing portion 290a are explained next.

The air lifter 180a lifts a small ball M1 that has entered from the first hopper 230a through the path switcher 270a, and feeds the lifted small ball M1 to either the marble-JP chance execution portion 140a or the ceiling housing portion 290a through the path switcher 280a.

The path switcher 280a selectively switches the path for passage of the small ball M1 lifted by the air lifter 180a to either the first path 60 or the second path 70. In the present embodiment, the path switcher 280a has a discharger 281a that receives the small ball M1 lifted by the air lifter 180a and discharges the received small ball M1. The discharger 281a is fixed to a rotation shaft 282a that is rotated by a driver such as a motor (not shown). The path switcher 280a selectively switches the path for passage of the small ball M1 lifted by the air lifter 180a to either the first path 60 or the second path 70. Specifically, the path switcher 280a selectively switches the position of a discharge port 283a for a small ball M1 to either a position above the first path 60 or a position above the second path 70. The discharge port 283a is provided on the discharger 281a.

The ceiling housing portion 290a is shared by the stations 100a, 100b, 100c, and 100d. The ceiling housing portion 290a houses small balls M1 to be selectively paid out to one of the game fields 110a, 110b, 110c, and 110d, from the JP payout portion 150a.

### 7. Flow of Small Balls M1 Related to Screw Lifter 170a

FIG. 10 is a diagram illustrating an example of the game field 110a, the count hopper 220a, the screw lifter 170a, the first hopper 230a, the second hopper 240a, the third hopper 250a, and the sorter 260a.

The station 100a additionally includes the paths 310a, 320a, 330a, and 340a for transporting small balls M1 as shown in FIG. 10. The paths 310a and 320a, the first hopper 230a, the second hopper 240a, and the third hopper 250a are included in a conveyor device 20 for the game. The conveyor device 20 for the game is used to transport small balls M1 in the game apparatus 10.

The path 340a and the screw lifter 170a are included in a feedback conveyor 30. The feedback conveyor 30 transports to the upstream of the path 310a at least one of small balls M1 used in the first hopper 230a, small balls M1 used in the second hopper 240a, and small balls M1 used in the third hopper 250a. With the feedback conveyor 30 transporting small balls M1 to the upstream of the path 310a, small balls M1 are enabled to circulate among the paths 310a and 320a, the first hopper 230a, the second hopper 240a or the third hopper 250a, and the feedback conveyor 30.

The feedback conveyor 30 can further receive entry of small balls M1 from the station 100b and transport the received small balls M1 to the upstream of the path 310a. Accordingly, small balls M1 can be supplemented from the station 100b via the feedback conveyor 30.

A combination of the conveyor device 20 for the game and the feedback conveyor 30 is included in a conveyor unit portion 90.

FIG. 10 also illustrates the paths 320b and 340b included in the station 100b. In FIG. 10, sidewalls of the paths 310a, 320a, 330a, 340a, 320b, and 340b are omitted to simplify the explanations.

The path 310a is at an angle that allows a small ball M1 to roll toward the path 320a. Small balls M1 lifted by the screw lifter 170a are discharged onto the path 310a. The small balls M1 can enter the first hopper 230a while rolling on the path 310a.

The path 320a is at an angle that allows small balls M1 to roll. Small balls M1 that have entered the path 320a can enter the second hopper 240a while rolling.

Among the small balls M1 having entered the path 320a, small balls M1 that have not entered the second hopper 240a can enter the third hopper 250a while rolling.

Among the small balls M1 having entered the path 320a, small balls M1 that have entered neither the second hopper 240a nor the third hopper 250a pass through the path 320a and then are brought into contact with the sorter 260a. Due to the contact with the sorter 260a, the moving directions of the small balls M1 are changed, thereby causing small balls M1 to be sorted into either the path 340a or the path 340b.

In other words, the sorter 260a can sort at least a part of small balls M1 that have passed through the path 320a without entering the second hopper 240a or the third hopper 250a in the conveyor unit portion 90 of the station 100a, into the feedback conveyor 30 included in the conveyor unit portion 90 of the station 100b. The sorter 260a is an example of a game object sorter and a sorter-to-another-game-apparatus.

For example, small balls M1 enter none of the first hopper 230a, the second hopper 240a, and the third hopper 250a in the station 100a because the first hopper 230a, the second hopper 240a, and the third hopper 250a are all full. Such small balls M1 can be sorted into the station 100b, which corresponds to another game apparatus. In this case, excessive supply of small balls M1 from the station 100a to the station 100b can be avoided. Furthermore, the sorter 260a can sort at least one or more of the small balls M1 that have passed through the path 320b without entering the second hopper 240b or the third hopper 250b in the conveyor unit portion 90 of the station 100b, into the feedback conveyor 30 included in the conveyor unit portion 90 of the station 100a. Therefore, excessive supply of small balls M1 from the station 100b to the station 100a can be avoided.

Since small balls M1 can move back and forth between the station 100a and the station 100b, imbalance in the number of small balls M1 between the station 100a and the station 100b can be improved even if such imbalance occurs. Therefore, for example, it is possible to reduce operations performed by a human administrator of the game apparatus 10 to adjust the numbers of small balls M1 in the stations 100a and 100b.

The sorter 260a has a face 261 facing toward the conveyor unit portion 90 of the station 100a and a face 262 facing toward the conveyor unit portion 90 of the station 100b. The faces 261 and 262 may be flat surfaces or curved surfaces. In the present embodiment, flat surfaces are used as the faces 261 and 262. The face 261 is at an angle that allows a small ball M1 to roll in a direction toward the path 340a. The face 262 is at an angle that allows a small ball M1 to roll in a direction toward the path 340b. A small ball M1 is sorted to the path 340a upon being brought into contact with the face 261 and is sorted to the path 340b upon being brought into contact with the face 262.

A part (hereinafter, also referred to as “specific part”) 263 where the face 261 and the face 261 are in contact with each other is the highest position in the sorter 260a. In the present embodiment, the sorter 260a is placed in such a manner in which a small ball M1 that has passed through the path 320a in the absence of small balls M1 therearound moves beyond the specific part 263 and reaches the face 262 and also in which a small ball M1 that has passed through the path 320b in the absence of small balls M1 therearound moves beyond the specific part 263 and reaches the face 261. Meanwhile, a small ball M1 that has decelerated on the path 320a due to collision against small balls M1 that are present in the surroundings sometimes cannot move beyond the specific part 263 and reaches the face 261 even if the small ball M was able to pass through the path 320a.

Similarly, a small ball M1 that has decelerated on the path 320b due to collision against small balls M1 in the surroundings sometimes cannot move beyond the specific part 263 and reaches the face 262 even if the small ball M1 was able to pass through the path 320b.

Among the small balls M1 fed into the game field 110a, small balls M1 that have fallen from the front edge 116 enter the path 330a. The path 330a is at an angle that allows a small ball M1 that has entered the path 330a to roll. The small balls M1 having entered the path 330a roll and enter the count hopper 220a.

Small balls M1 discharged from the count hopper 220a, small balls M1 sorted by the sorter 260a into the path 340a, small balls M1 that have fallen from the cutout 115L, small balls M1 that have fallen from the cutout 115R, small balls M1 used in the marble chance execution portion 130a, and small balls M1 used in the marble-JP chance execution portion 140a enter the path 340a.

The path 340a is at an angle that allows a small ball M1 to roll toward the screw lifter 170a. A path consisting of the path 310a and the path 320a is an example of a first path. The path 340a is an example of a second path. In the present embodiment, the path consisting of the path 310a and the path 320a is at an angle that allows a small ball M1 to roll horizontally from a first end to a second end of the path (from the starting point of the path 310a to the end point of the path 320a), as shown in FIG. 10, i.e., from the right to the left in the figure. The path 340a is at an angle that allows a small ball M1 to roll in a reverse horizontal direction (from the starting point of the path 340a to the end point thereof), i.e., from the left to the right in the figure. Therefore, the most upstream part of the path consisting of the path 310a and the path 320a and the most downstream part of the path 340a can be arranged in the same position horizontally. Accordingly, the screw lifter 170a can transport small balls M1 in a vertical direction or in a substantially vertical direction such that small balls M1 are raised while staying in the same position horizontally.

The path 340a is located substantially vertically below the path consisting of the path 310a and the path 320a. Accordingly, the position of the path consisting of the path 310a and the path 320a and the position of the path 340a can be substantially aligned with each other horizontally. The phrase, “substantially vertically below the path consisting of the path 310a and the path 320a” includes vertically below the path consisting of the path 310a and the path 320a. A state in which the path 340a is located substantially vertically below the path consisting of the path 310a and the path 320a includes a state in which the path 340a overlaps with a part of at least either the path 310a or 320a when the paths 310a, 320a, and 340a are seen in a planar view in a vertical direction.

### 8. Path 310a and First Hopper 230a

FIG. 11 is a diagram illustrating an example of the path 310a and the first hopper 230a as viewed in a plane from above. In the example show in FIG. 11, the path 310a is shared by the game unit portion 80a and a game unit portion 80c. Accordingly, a first hopper 230c of the game unit portion 80c in addition to the first hopper 230a is communicated with the path 310a.

The screw lifter 170a discharges lifted small balls M1 radially onto the path 310a.

The first hopper 230a houses small balls M1 entering from an entry port 231a provided on the path 310a and use the small balls M1. For example, small balls M1 discharged by the screw lifter 170a to a position upstream from the entry port 231a on the path 310a enter the first hopper 230a through the entry port 231a while rolling on the path 310a due to the angle of the path 310a.

Meanwhile, the first hopper 230c houses small balls M1 entering from an entry port 231c provided on the path 310a and uses the small balls M1. For example, small balls M1 discharged by the screw lifter 170a to a position upstream from the entry port 231c on the path 310a enter the first hopper 230c through the entry port 231c while rolling on the path 310a due to the angle of the path 310a.

In this way, small balls M1 roll due to the angle of the path 310a and enter the first hopper 230a or 230c. Therefore, as compared to a case in which small balls M1 are transported on the path 310a to the first hopper 230a or 230c using power, small balls M1 can be more efficiently transported because no power is used. It is to be noted that the entry port 231a and the entry port 231c are located at positions facing each other.

A regulator 350a is provided on the path 310a. In the present embodiment, the regulator 350a includes a sidewall 311a of the path 310a. The regulator 350a regulates the movement direction of small balls M1 on the path 310a to guide the small balls M1 to the entry port 231a or 231c. The regulator 350a has faces 351 and 352. The faces 351 and 352 may be flat surfaces or curved surfaces. In the present embodiment, flat surfaces are used as the faces 351 and 352. The face 351 is located downstream of the path 310a. The face 351 is provided in such a manner that a part of the face 351 that is farther from the entry port 231a in width W1 of the path 310a is positioned more upstream of the path 310a. Small balls M1 brought into contact with the face 351 roll along the face 351 to move toward the entry port 231a. The face 352 is also located downstream of the path 310a. The face 352 is provided in such a manner that a part of the face 352 that is farther from the entry port 231c in width W1 of the path 310a is positioned more upstream of the path 310a. Small balls M1 brought into contact with the face 352 roll along the face 352 to move toward the entry port 231c. Accordingly, small balls M1 are likely to enter the entry port 231a or 231c.

Among the small balls M1 lifted by the screw lifter 170a, small balls that have entered neither the first hopper 230a nor the first hopper 230c move to the path 320a from an outlet port 312a or 313a where the sidewall 311a is not provided. For example, small balls M1 that have entered the first hopper 230a due to sufficient small balls M1 housed in the first hopper 230a move to the path 320a from the outlet port 312a.

### 9. Path 320a, Second Hopper 240a, and Third Hopper 250a

FIG. 12 is a diagram illustrating an example of the path 320a, the second hopper 240a, and the third hopper 250a as viewed in a plane from above. In the example shown in FIG. 12, the path 320a is shared by the game unit portion 80a and the game unit portion 80c. Accordingly, a second hopper 240c of the game unit portion 80c, in addition to the second hopper 240a, is communicated with the path 320a. A third hopper 250c of the game unit portion 80c, in addition to the third hopper 250a, is also communicated with the path 320a.

The second hopper 240a houses small balls M1 entering from an entry port 241a provided on the path 320a and uses the small balls M1. For example, small balls M1 entering from the path 310a to a position upstream from the entry port 241a on the path 320a enter the second hopper 240a through the entry port 241a while rolling on the path 320a due to the angle of the path 320a. Meanwhile, the second hopper 240c houses small balls M1 entering from an entry port 241c provided on the path 320a and uses the small balls M1. For example, small balls M1 entering from the path 310a to a position upstream from the entry port 241c on the path 320a enter the second hopper 240c through the entry port 241c while rolling on the path 320a due to the angle of the path 320a. The entry port 241a and the entry port 241c are located at positions facing each other.

The third hopper 250a houses, from among small balls M1 having entered neither the second hopper 240a nor 240c, small balls M1 that have entered from an entry port 251a provided on the path 320a and uses the small balls M1. For example, small balls M1 entering from the path 310a to a position upstream from the entry port 251a on the path 320a enter the third hopper 250a through the entry port 251a while rolling on the path 320a due to the angle of the path 320a. Meanwhile, the third hopper 250c houses, from among the small balls M1 having entered neither the second hopper 240a nor 240c, small balls M1 that have entered from an entry port 251c provided on the path 320a and uses the small balls M1. For example, small balls M1 entering from the path 310a to a position upstream from the entry port 251c on the path 320a enter the third hopper 250c through the entry port 251c while rolling on the path 320a due to the angle of the path 320a. The entry port 251a and the entry port 251c are located at positions facing each other.

In this way, small balls M1 roll on the path 320a due to the angle of the path 320a and enter the second hopper 240a or 240c or the third hopper 250a or 250c. Accordingly, as compared to a case in which small balls M1 are transported using power to the second hopper 240a or 240c or the third hopper 250c or 250c on the path 320a, small balls M1 can be more efficiently transported because no power is used.

The entry ports 241a and 241c are located upstream of the path 320a. The entry ports 251a and 251c are located downstream of the path 320a. Accordingly, either the entry port 251a or 251c can receive small balls M1 having entered neither the entry port 241a nor 241c. Therefore, small balls M1 rolling on the path 320a are likely to enter any of the entry ports 241a, 241c, 251a, and 251c.

On the path consisting of the paths 310a and 320a, the entry ports 231a and 231c are located upstream of the path, the entry ports 241a and 241c are located downstream from the entry ports 231a and 231c, and the entry ports 251a and 251c are located downstream from the entry ports 241a and 241c. Therefore, small balls M1 rolling on the path consisting of the paths 310a and 320a are likely to enter any of the entry ports 231a, 231c, 241a, 241c, 251a, and 251c.

Regulators 360a, 370a, 380a, and 390a are provided on the path 320a. In the present embodiment, each of the regulators 360a, 370a, 380a, and 390a is constituted of a protrusion that extends from the path 320a.

The regulator 360a is located upstream from the entry ports 241a and 241c. The regulator 360a regulates the movement direction of small balls M1 on the path 320a to guide the small balls M to the entry port 241a or 241c. Specifically, the regulator 360a has a face 361 and a face 362. The faces 361 and 362 may be flat surfaces or curved surfaces. In the present embodiment, flat surfaces are used as the faces 361 and 362. The face 361 is located in such a manner that a part of the face 361 that is farther from the entry port 241a in width W2 of the path 320a is positioned more upstream of the path 320a. Small balls M1 brought into contact with the face 361 move toward the entry port 241a by rolling along the face 361. The face 362 is located in such a manner that a part of the face 362 that is farther from the entry port 241c in width W2 of the path 320a is positioned more upstream of the path 320a. Small balls M1 brought into contact with the face 362 move toward the entry port 241c by rolling along the face 362. Accordingly, small balls M1 are likely to enter the entry port 241a or 241c.

The regulator 370a is located downstream from the entry ports 241a and 241c and upstream from the entry ports 251a and 251c. The regulator 370a regulates the movement direction of small balls M1 on the path 320a to guide the small balls M1 to the entry port 241c or the regulator 390a. Specifically, the regulator 370a has faces 371 and 372. The faces 371 and 372 can be flat surfaces or curved surfaces. In the present embodiment, flat surfaces are used as the faces 371 and 372. The face 371 is located in such a manner that a part of the face 371 that is farther from the entry port 241c in width W2 of the path 320a is positioned more downstream of the path 320a. Small balls M1 brought into contact with the face 371 move toward the entry port 241c by rolling along the face 371. Accordingly, small balls M1 are likely to enter the entry port 241c. The face 372 is parallel to the length axis (an axis orthogonal to the width W2) of the path 320a. Small balls M1 brought into contact with the face 372 move toward the regulator 390a by rolling along the face 372.

The positional relationship with the entry port 241a in the regulator 380a is substantially the same as the positional relationship with the entry port 241c in the regulator 370a. Specifically, the regulator 380a has faces 381 and 382, the face 381 corresponds to the face 371, and the face 382 corresponds to the face 372. The faces 381 and 382 may be flat surfaces or curved surfaces. In the present embodiment, flat surfaces are used as the faces 381 and 382. The positional relationship with the entry ports 251a and 251c in the regulator 390a is substantially the same as the positional relationship with the entry ports 241a and 241c in the regulator 360a. Specifically, the regulator 390a has faces 391 and 392, the face 391 corresponds to the face 361, and the face 392 corresponds to the face 362. The faces 391 and 392 may be flat surfaces or curved surfaces. In the present embodiment, flat surfaces are used as the faces 391 and 392.

From among the small balls M1 having entered the path 320a, small balls M1 that have entered none of the second hoppers 240a and 240c and the third hoppers 250a and 250c move toward the sorter 260a from an outlet port 322a where sidewalls 321a are not provided. The outlet port 322a is an example of a game object supply portion.

### 10. Paths 330a and 340a and Count Hopper 220a

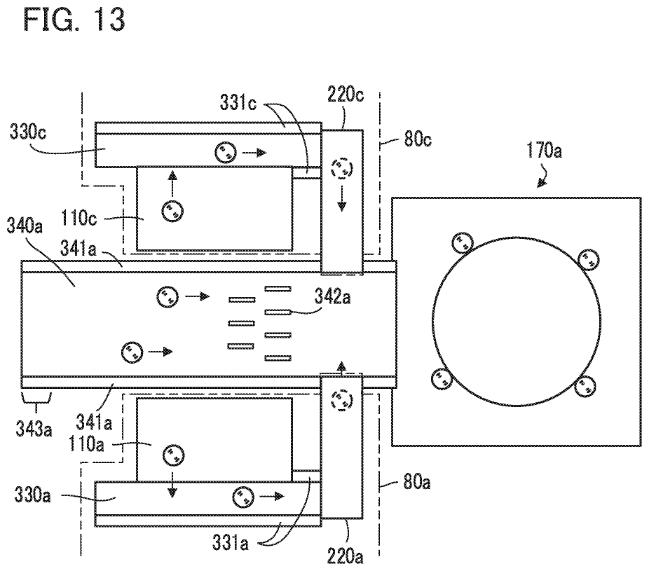

FIG. 13 is a view illustrating an example of the game field 110a, the paths 330a and 340a, and the count hopper 220a as viewed in a plane from above. In the example shown in FIG. 13, the path 340a is shared by the game unit portion 80a and the game unit portion 80c. Accordingly, small balls M1 that have fallen from the game field 110a in the game unit portion 80a and thereafter having passed the path 330a and the count hopper 220a enter the path 340a, and small balls M1 that have fallen from the game field 110c in the game unit portion 80c and thereafter having passed a path 330c and a count hopper 220c enter the path 340a. The path 330a has sidewalls 331a and the path 330c has sidewalls 331c.

A game object receiver 343a is provided on the path 340a. The game object receiver 343a receives small balls M1 sorted by the sorter 260a into the conveyor unit portion 90 of the station 100a The game object receiver 343a is an example of a shared game object receiver.

Sidewalls 341a and slits 342a are provided on the path 340a. The width of the slits 342a is smaller than the diameter of the small balls M1. The small balls M1 may chip during circulation in the game apparatus 10. Chips of small balls M1 may possibly accumulate on the path 340a and may hinder the rolling of the small balls M1. The slits 342a allow these chips of the small balls M1 to fall from the path 340a, thereby prevent the chips from being accumulated on the path 340a and hindering the rolling of small balls M1. The slits 342a may be provided on at least one of the paths 310a, 320a, and 330a. It is to be noted that a collection case for collecting chips of small balls M1 that fall from the path through the slits 342a may be provided below the slits 342a. Small balls M1 having passed through the path 340a move to the screw lifter 170a.

As described above, the paths 310a, 320a, and 340a are shared by the game unit portions 80a and 80c. Accordingly, the configuration can be simplified as compared to a case in which the paths 310a, 320a, and 340a are not shared and dedicated paths are used for each of the game unit portion 80a and the game unit portion 80c. Furthermore, the paths 310a, 320a, and 340a are shared by the game unit portions 80a and 80c adjacent to each other. Therefore, the distances between the paths 310a, 320a, and 340a and the game unit portions 80a and 80c can be shortened.

### 11. Screw Lifter 170a

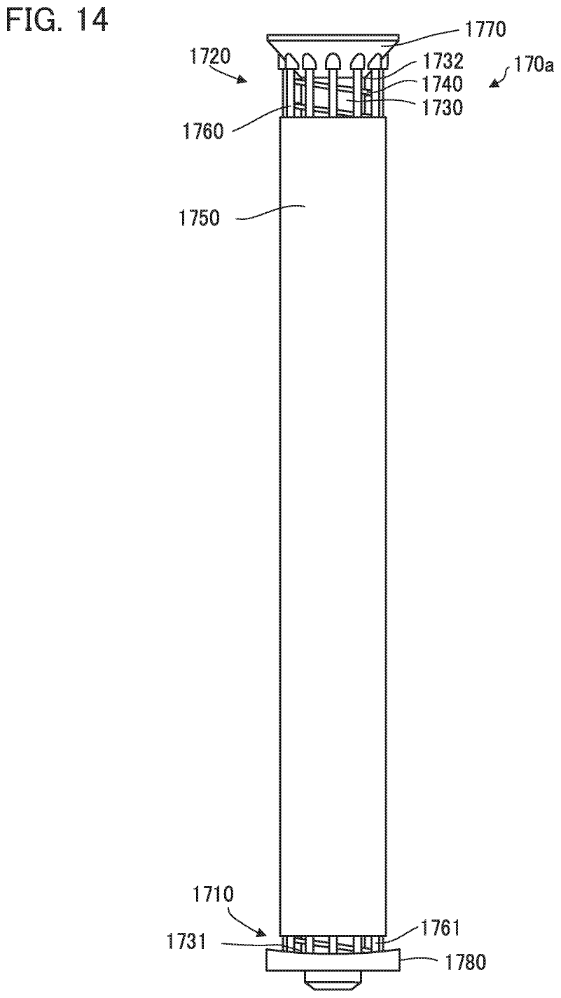

FIG. 14 is a diagram illustrating an example of the screw lifter 170a. The screw lifter 170a is an example of a conveyor device. The screw lifter 170a includes a take-in portion 1710 that takes in small balls M1, and a discharger 1720 that discharges small balls M1. The screw lifter 170a is mounted in such a manner that the discharger 1720 is positioned higher than the take-in portion 1710. The screw lifter 170a lifts small balls M1 taken in from the take-in portion 1710 and discharges the lifted small balls M1 from the discharger 1720. The screw lifter 170a transports small balls M1 having entered from the path 340a substantially vertically upward to the path 310a (see FIG. 10). Accordingly, the transport route of small balls M1 in the screw lifter 170a can be shortened. “Substantially vertical” indicates that the inclination relative to the vertical is within a predetermined angle (for example, 30 degrees). The predetermined angle is not limited to 30 degrees, and it is sufficient for the predetermined angle to be within a range in which inclination at the predetermined angle relative to the vertical can be regarded as being vertical. Therefore, the predetermined angle may be not less than 0 degrees and less than 30 degrees, but may be greater than 30 degrees. In the present embodiment, it is assumed that the predetermined angle is 0 degrees.

The screw lifter 170a includes a rotating body 1730, a supporter 1740, an encircling member 1750, guides 1760, a holder 1770, and a supply portion 1780.

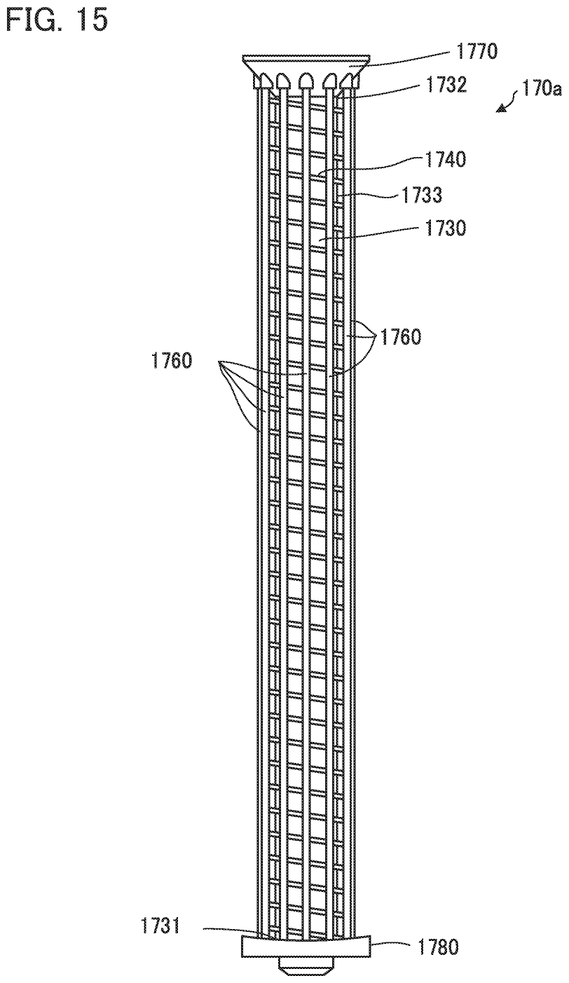

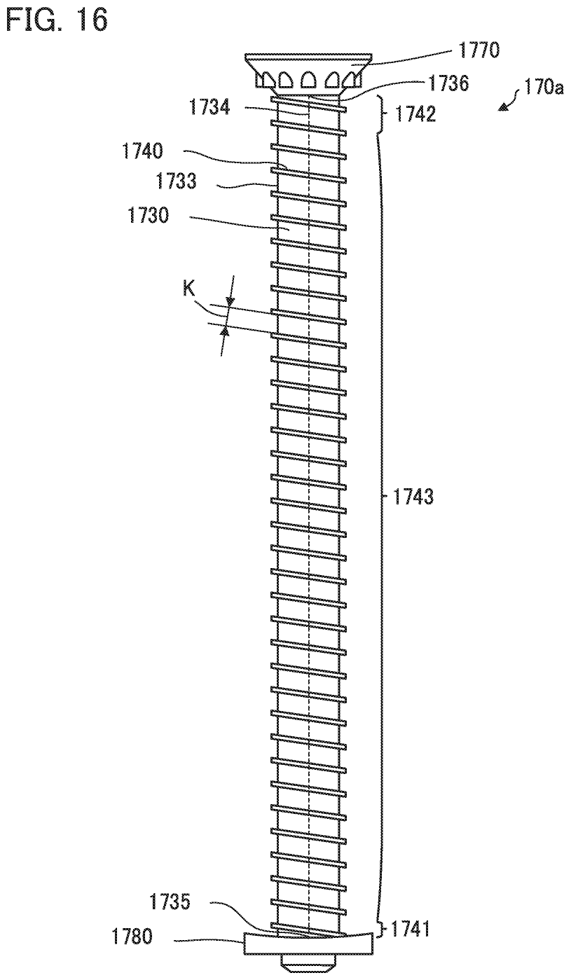

FIG. 15 is a diagram illustrating the screw lifter 170a. The encircling member 1750 is not shown in the diagram. FIG. 16 is a diagram illustrating the screw lifter 170a. The encircling member 1750 and the guides 1760 are not shown in the diagram.

The rotating body 1730 is rotatable about a rotation axis 1734 (see FIG. 16) passing through the rotating body 1730. Accordingly, the rotating body 1730 itself also functions as a rotation axis. The rotating body 1730 and the rotation axis 1734 extend vertically. As shown in FIG. 14, the take-in portion 1710 is located on one end (hereafter, “first end”) 1731 of the rotating body 1730, in other words, on one end (hereafter, “first end”) 1735 of the rotation axis 1734. The discharger 1720 is located on the other end (hereafter, “second end”) 1732 of the rotating body 1730, in other words, on the other end (hereafter, “second end”) 1736 of the rotation axis 1734. The direction in which the rotating body 1730 extends is not limited to the vertical direction and it is sufficient for the direction to be a direction that positions the discharger 1720 higher than the position of the take-in portion 1710.

As shown in FIG. 16, the supporter 1740 extends from the first end 1735 of the rotation axis 1734 to the second end 1736 thereof in a helical manner. In the present embodiment, the supporter 1740 is located on a side surface 1733 of the rotating body 1730. Therefore, the supporter 1740 can rotate with the rotating body 1730 about the rotation axis 1734.

The supporter 1740 has a first portion 1741, a second portion 1742, and a third portion 1743. The first portion 1741 is a part of the supporter 1740 on the first end 1735 of the rotation axis 1734. The first portion 1741 is included in the take-in portion 1710. The second portion 1742 is a part of the supporter 1740 on the second end 1736 of the rotation axis 1734. The second portion 1742 is included in the discharger 1720. The third portion 1743 is a part of the supporter 1740 between the first portion 1741 and the second portion 1742.

The encircling member 1750 encircles the third portion 1743. The encircling member 1750 is a cylindrical member. The entirety or a part of the encircling member 1750 is formed of, for example, a transparent material. When the encircling member 1750 is formed of a transparent material, transport of small balls M1 by the screw lifter 170a can be seen by the player. Accordingly, visual amusement can be provided to the player. The encircling member 1750 is not necessarily formed of a transparent material.

In the present embodiment, the encircling member 1750 does not encircle the first portion 1741 or the second portion 1742. The supporter 1740 takes in a small ball M1 through the first portion 1741 that is not encircled by the encircling member 1750. The supporter 1740 discharges a small ball M1 through the second portion 1742 that is not encircled by the encircling member 1750.

The guides 1760 extend from the first end 1735 of the rotation axis 1734 to the second end 1736 thereof within a gap between the supporter 1740 and the encircling member 1750. In the present embodiment, 12 columnar guides 1760 are used. The gap between adjacent guides 1760 is larger than the diameter of the small balls M1. The guides 1760 are provided within the gap between the supporter 1740 and the encircling member 1750 in such a manner that a small ball M1 that has entered a gap between two guides 1760 can move within the gap between the two guides 1760, but cannot move to a gap between the right one of the two guides 1760 and a guide 1760 further to the right, or to a gap between the left one of the two guides 1760 and a guide 1760 further to the left. That is, the clearance between the supporter 1740 and the guides 1760 and the clearance between the encircling member 1750 and the guides 1760 are both smaller than the diameter of the small balls M1. For example, as shown in FIG. 14, the guides 1760 can be provided to be in contact with the inner circumferential surface of the encircling member 1750 to cause the clearance between the encircling member 1750 and the guides 1760 to be smaller than the diameter of the small balls M1.

Each of the guides 1760 guides movement of a small ball M1 from the first end 1735 of the rotation axis 1734 to the second end 1736 thereof along with rotation of the supporter 1740 while supporting the small ball M1 in coordination with the supporter 1740 and the encircling member 1750. In the example shown in FIGS. 14 to 19, the supporter 1740 rotates counterclockwise when viewed vertically from above the rotation axis 1734. The supporter 1740 extends from the first end 1735 of the rotation axis 1734 to the second end 1736 thereof in a helical manner so as to be clockwise when viewed from vertically above. The 12 guides 1760 extend linearly from the first end 1735 of the rotation axis 1734 to the second end 1736 within the gap between the supporter 1740 and the encircling member 1750. When the supporter 1740 rotates counterclockwise, each small ball M1 is pressed against the corresponding guide 1760 from the left side thereof, and the small ball M1 moves from the first end 1735 of the rotation axis 1734 to the second end 1736 thereof along the corresponding guide 1760. As described above, each small ball M1 that has entered the gap between two of the guides 1760 moves along the corresponding guides 1760 without moving to adjacent gaps. Accordingly, the screw lifter 170a has 12 transport routes and as many guides 1760, and can simultaneously transport small balls M1 simultaneously using the 12 transport routes.

In the present embodiment, the guides 1760 also extend in both directions to the first end 1735 (the take-in portion 1710) of the rotation axis 1734 and to the second end 1736 (the discharger 1720) from the gap between the supporter 1740 and the encircling member 1750. A portion 1761 of each of the guides 1760 extending in the take-in portion 1710 guides taking-in of a small ball M1 in the take-in portion 1710.

The guides 1760 and the encircling member 1750 are fixed to each other by screws, an adhesive, or the like. This enables the positional relationship between the guides 1760 and the encircling member 1750 to be constant.

### 12. Take-in Portion 1710

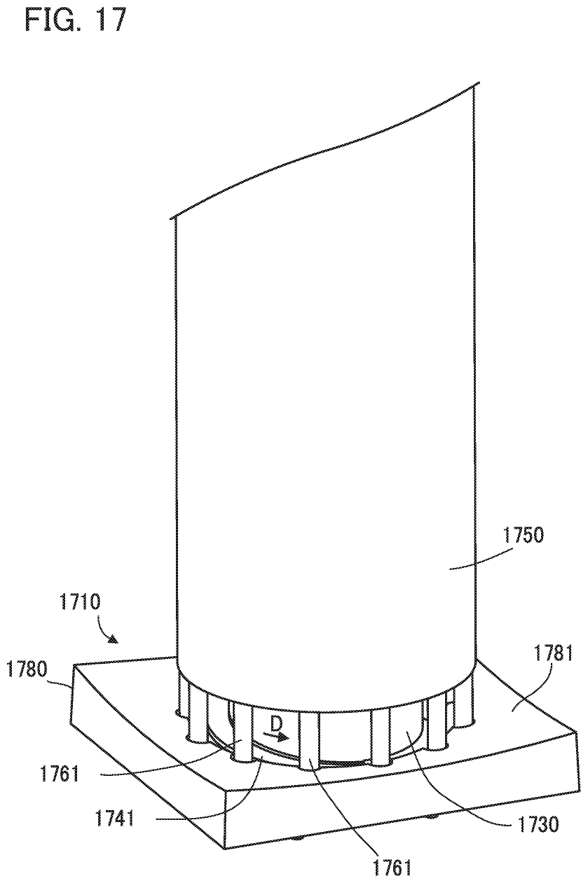

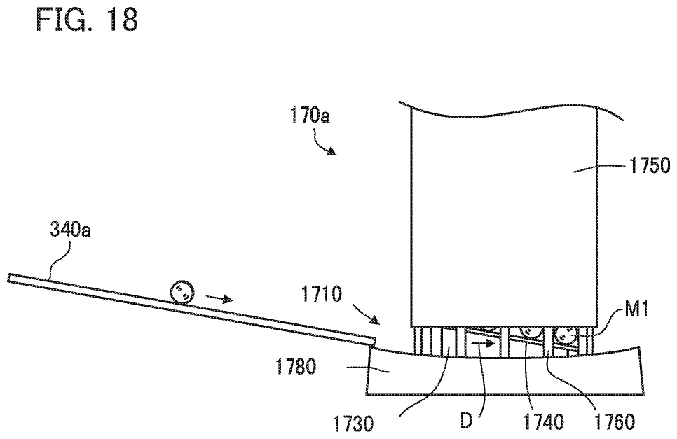

FIG. 17 is a perspective view mainly illustrating the take-in portion 1710 of the screw lifter 170a. FIG. 18 is a diagram illustrating an example of the take-in portion 1710 and the path 340a.

As shown in FIG. 13, small balls M1 that have entered the path 340a from the game unit portion 80a and small balls M1 that have entered the path 340a from the game unit portion 80c pass through the path 340a and then reach the supply portion 1780 of the screw lifter 170a (see FIG. 18). A sidewall may be formed around the supply portion 1780 to prevent small balls M1 having reached the supply portion 1780 from falling from the supply portion 1780.

As shown in FIG. 17, the supply portion 1780 includes a slope 1781 that is at an angle that allows a small ball M1 present near the first portion 1741 to roll toward the first portion 1741. The slope 1781 may have a flat surface or have a curved surface. In the present embodiment, a curved surface is used as the slope 1781. The slope 1781 is at an angle so that the height decreases toward the first portion 1741.

A small ball M1, having reached the supply portion 1780 reaches the first portion 1741 through a space between guides 1760, that is in the take-in portion 1710 after rolling on the slope 1781. Accordingly, the efficiency of taking in small balls M1 can be increased as compared to a case in which the slope 1781 (the supply portion 1780) is not provided. Furthermore, since a small ball M1 rolls on the slope 1781 by its own weight and reaches the first portion 1741, the transport efficiency can be increased without using any power, as compared to a case in which a small ball M1 is supplied to the first portion 1741 using power. As shown in FIG. 13, small balls M1 are collected at the supply portion 1780 from the game unit portions 80a and 80c, and the supply portion 1780 then supplies the collected small balls M1 to the first portion 1741. Therefore, the screw lifter 170a can be shared by the game unit portions 80a and 80c.

The supporter 1740 rotates in the direction of an arrow D along with the rotating body 1730 as shown in FIGS. 17 and 18. With this rotation, the first portion 1741 slips under small balls M1 and lifts the small balls M1. Accordingly, the take-in portion 1710 can take in small balls M1 through the first portion 1741 from 360 degrees in any direction around the first portion 1741.

When lifted by the first portion 1741, a small ball M1 rolls along the angle of the first portion 1741 and collides against a guide 1760 (specifically, a portion 1761) that is in the take-in portion 1710. Therefore, rolling of the small ball M1 due to the supporter 1740 is regulated by the guide 1760.

When the supporter 1740 further rotates, the small ball M1 enters a gap between the encircling member 1750 and the rotating body 1730 while being supported by the supporter 1740 and the guide 1760. That is, the taking-in of the small ball M1 is completed. In this way, the guide 1760 can also be used as a taking-in member for a small ball M1 in the present embodiment.

When entering the gap between the encircling member 1750 and the rotating body 1730, the small ball M1 is also supported by the encircling member 1750 in addition to the supporter 1740 and the guide 1760.

When the supporter 1740 further rotates with the small ball M1 being supported by the supporter 1740, the guide 1760, and the encircling member 1750, the small ball M1 is transported toward the discharger 1720 along the guide 1760.

### 13. Discharger 1720

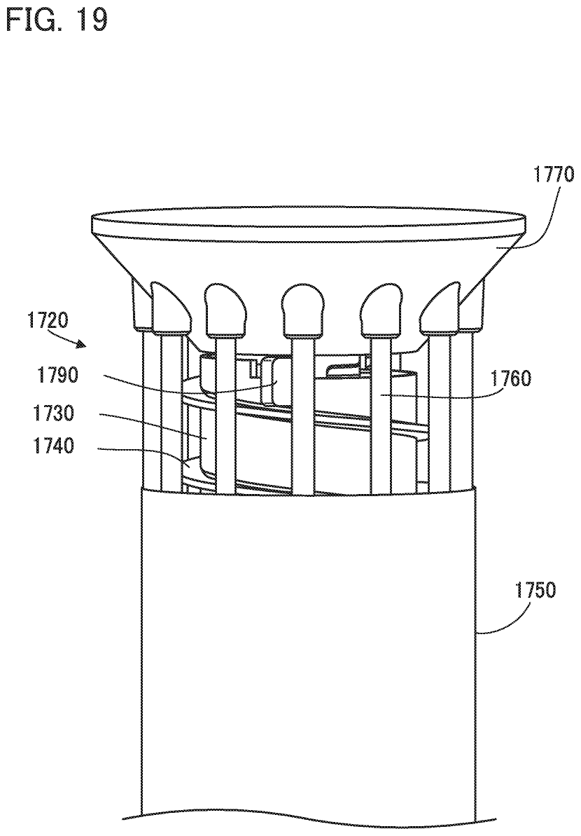

FIG. 19 is a perspective view mainly illustrating the discharger 1720 of the screw lifter 170a.

When a small ball M1 reaches the discharger 1720, the small ball M1 is no longer supported by the encircling member 1750. Consequently, the small ball M1 is discharged from the discharger 1720 through the second portion 1742 of the supporter 1740. Because the discharger 1720 is not encircled by the encircling member 1750, small balls M1 can be discharged from 360 degrees in any direction around the second portion 1742.

In the present embodiment, an ejection portion (protrusion) 1790 that ejects a small ball M1 having reached the discharger 1720 is provided on the second portion 1742. The ejection portion 1790 collides with a small ball M1 as the supporter 1740 rotates, thereby causing the small ball M1 to be discharged outside the discharger 1720 (see FIG. 11). With the ejection portion 1790, it is possible to prevent small balls M1 from remaining in the discharger 1720.

### 14. Ceiling Housing Portion 290a

FIG. 20 is a sectional view along a line L-L in FIG. 2, mainly illustrating an example of the ceiling housing portion 290a. FIG. 21 is a sectional view along a line E-E in FIG. 20. The ceiling housing portion 290a is shared by the stations 100a, 100b, 100c, and 100d. The internal space of the game apparatus 10 is partitioned by a partition member 400 into a game field space 410a and a small ball housing space 420. Accordingly, the partition member 400 can be used as the bottom of the small ball housing space 420 and also as the ceiling of the game field space 410. Therefore, the configuration can be simplified as compared to a case in which the bottom of the small ball housing space 420 and the ceiling of the game field space 410 are formed from separate members. The partition member 400 is an example of a first member.

The game field space 410 is a space in which a game field housing portion 430 houses the game fields 110a, 110b, 110c, and 110d, and the like. The game field housing portion 430 is constituted of a first housing member 440 and the partition member 400.

The small ball housing space 420 is an example of a game object housing space. The small ball housing space 420 is a space in which the ceiling housing portion 290a houses small balls M1. The ceiling housing portion 290a is an example of a game object housing portion. The ceiling housing portion 290a is constituted of a second housing member 450 and the partition member 400. The first housing member 440 and the second housing member 450 are fixed to each other with screws or the like. The ceiling housing portion 290a is located above the game field housing portion 430. Accordingly, a space above the game field housing portion 430 can be effectively utilized.

The game apparatus 10 further includes a supply path 460, a feeding portion 470, and a supporter 480.

The supply path 460 supplies small balls M1 housed in the ceiling housing portion 290a into the game field space 410. In the present embodiment, the supply path 460 selectively supplies small balls M1 to any of the game fields 110a, 110b, 110c, and 110d via the JP payout portion 150a. A path switcher 151a that switches the payout direction (destination) of small balls M1 is provided on the JP payout portion 150a. The path switcher 151a has a discharge port for discharging small balls M1 supplied to the JP payout portion 150a. The position of the discharge port of the path switcher 151a is selectively switched to one of the game fields 110a, 110b, 110c, and 110d.

The feeding portion 470 feeds the small balls M1 housed in the ceiling housing portion 290a into the game field space 410. In the present embodiment, the feeding portion 470 selectively supplies the small balls M1 housed in the ceiling housing portion 290a to one of the game fields 110a, 110b, 110c, and 110d via the supply path 460 and the JP payout portion 150a.

The supporter 480 supports a plate-like member 4020 (described later). The supporter 480 is moved by the feeding portion 470.

The partition member 400 is constituted of plate-like members 4010, 4020, and 4030. The plate-like members 4010, 4020, and 4030 are formed of a transparent material. Accordingly, small balls M1 housed in the small ball housing space 420 can be presented to the player and a sense of amusement can be provided to the player. It is to be noted that a part or the entirety of the partition member 400 may be formed of a transparent material or the entirety of the partition member 400 may be formed of a nontransparent material.

The plate-like members 4010 and 4030 are fixed to the game apparatus 10. The plate-like member 4020 is swingably connected to the plate-like member 4030. In the present embodiment, the plate-like member 4020 is swingable around a shaft 405 located at a connection portion with the plate-like member 4030. The plate-like member 4020 has a face (top face) 4021 facing the small ball housing space 420; and the plate-like member 4030 has a face (top face) 4031 facing the small ball housing space 420. The face 4021 is in contact with the face 4031 at a contact portion 404. The face 4021 and the face 4031 together form a part of an inner bottom surface of the small ball housing space 420. The contact portion 404 is an example of a specific portion.

The plate-like member 4010 has a face (top face) 4011 facing the small ball housing space 420. The face 4011 and the face 4031 each are a slope that is at an angle that allows small balls M1 to roll toward the contact portion 404. While the faces 4011, 4021, and 4031 are flat surfaces, these faces may be curved surfaces.

The ceiling housing portion 290a are operable in two different states: a first state in which small balls M1 are accumulated in the ceiling housing portion 290a and a second state in which small balls M1 housed in the ceiling housing portion 290a are fed to the game field space 410. In the first state, the feeding portion 470 rotates the supporter 480 to bring the face 4021 to be a slope that is at an angle that allows the small balls M1 to roll toward the contact portion 404 (see FIGS. 20 and 21). When small balls M1 are fed in the first state to the ceiling housing portion 290a from the first path 60 of at least one of the stations 100a, 100b, 100c, and 100d, the small balls M1 roll toward the contact portion 404 and are accumulated in the ceiling housing portion 290a. Accordingly, for example, as compared to a case in which small balls M1 are transported, in the ceiling housing portion 290a, to the contact portion 404 using power, small balls M1 can be more efficiently collected to the contact portion 404 because no power is used.

In the second state, the feeding portion 470 rotates the supporter 480 to change the face 4021 to be at an angle that allows small balls M1 to roll to the supply path 460 from an angle that allows small balls M1 to roll toward the contact portion 404.

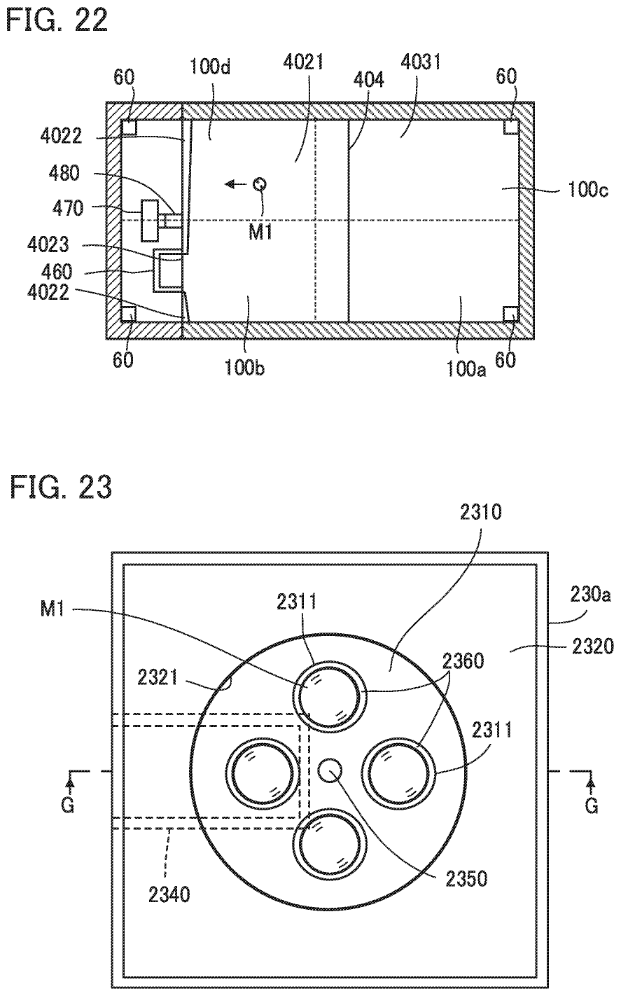

FIG. 22 is a sectional view along a line F-F in FIG. 20 when the face 4021 is changed to have an angle that allows small balls M1 to roll to the supply path 460. In this state, small balls M1 roll on the face 4021 toward the supply path 460 and then move into the supply path 460 through an outlet port 4023 along a guide 4022 that is, for example, a protrusion on the face 4021. Since the angle thus causes small balls M1 to roll toward the supply path 460, the small balls M1 can be more efficiently moved to the supply path 460 because no power is used, as compared to a case in which small balls M1 are moved using power. The small balls M1 then roll on the supply path 460 and enter the JP payout portion 150a. The small balls M1 then are fed to any of the game fields 110a, 110b, 110c, and 110d, from the path switcher 151a of the JP payout portion 150a.

When the small balls M1 housed in the ceiling housing portion 290a are paid out from the JP payout portion 150a, the feeding portion 470 rotates the supporter 480 to bring the face 4021 to be a slope that is at an angle that allows small balls M1 to roll toward the contact portion 404. At least one of the air lifters 180a, 180b, 180c, and 180d then lifts small balls M1, and the lifted small balls M1 are fed to the ceiling housing portion 290a. It is to be noted that the number of small balls M1 lifted by the air lifter 180a is controlled by the first hopper 230a. Similarly, the numbers of small balls M1 lifted by the air lifters 180b, 180c, and 180d are controlled by first hoppers 230b, 230c, and 230d, respectively.

### 15. Hoppers 230a, 240a, and 250a

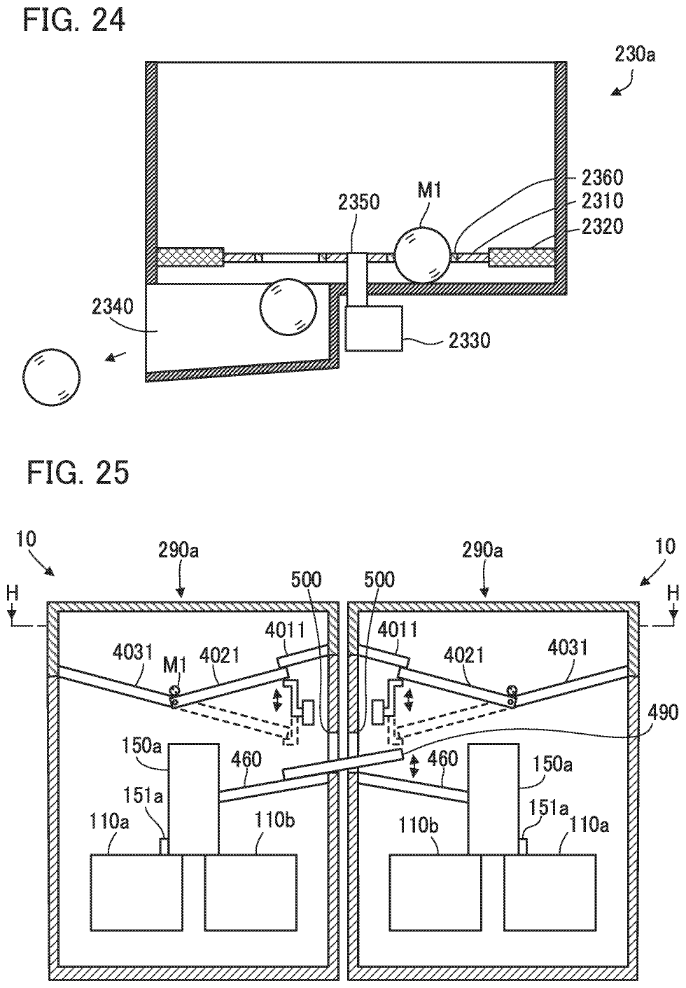

FIG. 23 is a diagram illustrating an example of the first hopper 230a. FIG. 24 is a sectional view along a line G-G in FIG. 23.

The first hopper 230a includes a rotary disk 2310, a disk guide member 2320, a motor 2330, a delivery portion 2340, a shaft 2350, and brushes 2360.

The rotary disk 2310 is disk-shaped and is fixed at the center to the shaft 2350 that transmits power of the motor 2330. The rotary disk 2310 has four small-ball delivery holes 2311 at equal intervals in the circumferential direction. The number of the small-ball delivery holes 2311 is not limited to “4” and can be appropriately changed. The brushes 2360 for cleaning small balls M1 are mounted respectively on the inner walls of the small-ball delivery holes 2311.

A circular guide hole 2321 is provided on the disk guide member 2320. The rotary disk 2310 is fitted in the guide hole 2321.

A small ball M1, having entered the small-ball delivery hole 2311, is guided to the delivery portion 2340 with rotation of the rotary disk 2310. When reaching the delivery portion 2340 in a state of being in the small-ball delivery hole 2311, the small ball M1 falls in the delivery portion 2340 and is then discharged from the delivery portion 2340. When the small ball M1 falls in the delivery portion 2340, chips of the small ball M1 are removed from the small ball M1 by the brush 2360.

The second hopper 240a and the third hopper 250a have the same configuration as that of the first hopper 230a. Accordingly, explanations of the second hopper 240a and the third hopper 250a are omitted.

### B. Modifications

The embodiment illustrated above can be variously modified as follows by way of example. One or more modifications freely selected from the modifications described below may be combined with others as appropriate.

### First Modification

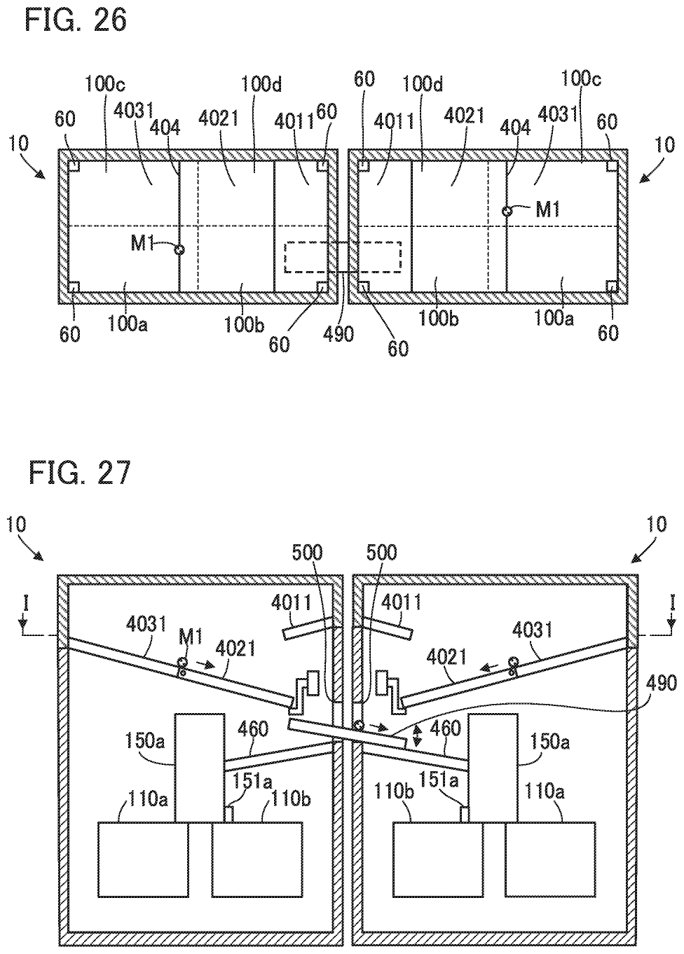

The ceiling housing portions 290a of a plurality of the game apparatuses 10 may be coupled to one another. FIG. 25 is a diagram illustrating an example in which the ceiling housing portions 290a of two game apparatuses 10 are coupled to each other. FIG. 26 is a sectional view along a line H-H in FIG. 25.

In the first modification, a through hole 500 that allows a small ball M1 to pass through is provided on each of the two game apparatuses 10. The through holes 500 of the two game apparatuses 10 are located at positions facing each other. A path switcher 490 that switches the path for small balls M1 is located at a position passing through the through holes 500 of the two game apparatuses 10. The path switcher 490 switches the supply destination of small balls M1 housed in each of the ceiling housing portions 290a between the supply path 460 of one of the game apparatuses 10 and the supply path 460 of the other game apparatus 10.

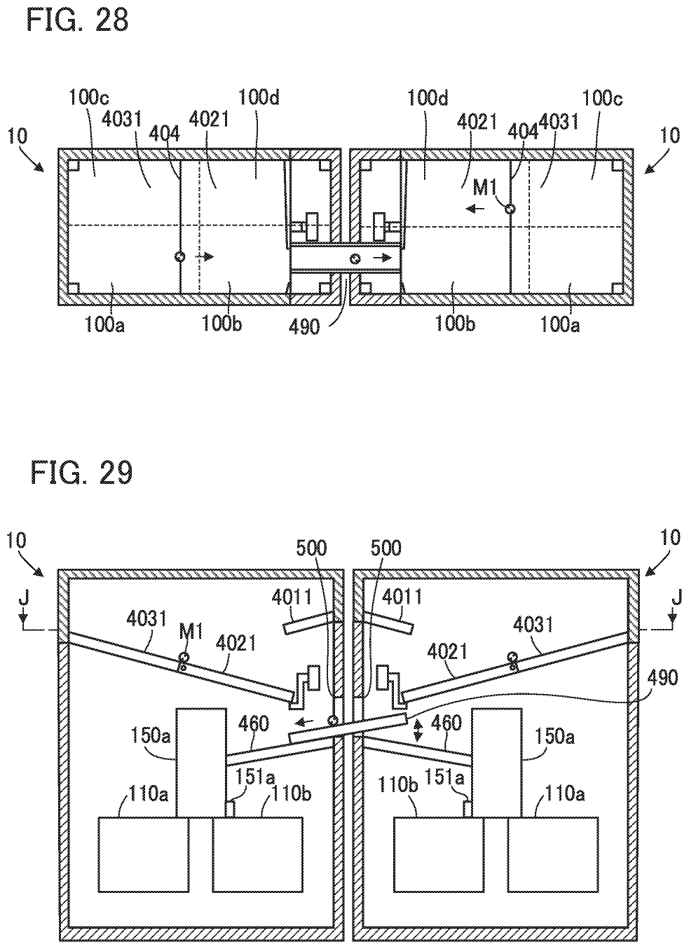

FIG. 27 is a diagram illustrating an example in a case in which the supply destination of small balls M1 is set to the supply path 460 of one of the game apparatuses 10 (the game apparatus 10 on the right in FIG. 27, hereafter, “first game apparatus”) in the first modification. FIG. 28 is a sectional view along a line I-I in FIG. 27. As shown in FIGS. 27 and 28, in the case in which the supply destination of small balls M1 is set to the supply path 460 of the first game apparatus 10, the angle of the path switcher 490 is changed to be at an angle that allows small balls M1 to roll toward the supply path 460 of the first game apparatus 10. Specifically, the angle of the path switcher 490 is changed such that the height of the path switcher 490 decreases from an end of the path switcher 490 in the other game apparatus 10 (the game apparatus 10 on the left in FIG. 27, hereafter, “second game apparatus”) to the other end of the path switcher 490 in the first game apparatus 10. Accordingly, small balls M1 that have entered the path switcher 490 from the ceiling housing portions 290a of the game apparatuses 10 roll toward the supply path 460 of the first game apparatus 10.

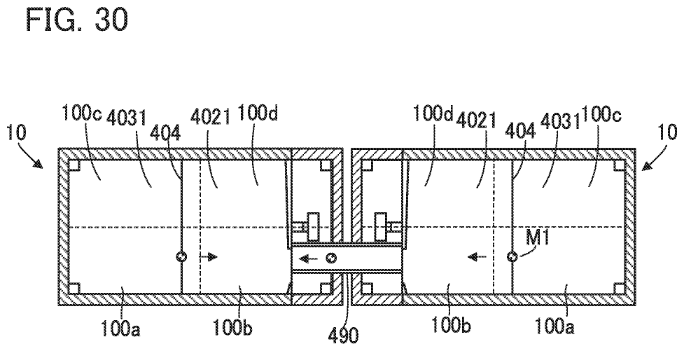

FIG. 29 is a diagram illustrating an example in a case in which the supply destination of small balls M1 is set to the supply path 460 of the second game apparatus 10 in the first modification. FIG. 30 is a sectional view along a line J-J in FIG. 29. As shown in FIGS. 29 and 30, in the case in which the supply destination of small balls M1 is set to the supply path 460 of the second game apparatus 10, the angle of the path switcher 490 is changed to be at an angle that allows small balls M1 to roll toward the supply path 460 of the second game apparatus 10. Specifically, the angle of the path switcher 490 is changed such that the height of the path switcher 490 decreases from one end of the path switcher 490 in the first game apparatus 10 to the other end of the path switcher 490 in the second game apparatus 10. Accordingly, small balls M1 that have entered the path switcher 490 from the ceiling housing portions 290a of the game apparatuses 10 roll toward the supply path 460 of the second game apparatus 10.

It is to be noted that changing of the angle of the path switcher 490 is performed by a driver such as a motor (not shown).

According to the first modification, small balls M1 housed in the ceiling housing portions 290a are fed to one station at the time of the execution of a marble JP. Therefore, more small balls M1 can be fed at the time of the execution of a marble JP as compared to a case in which small balls M1 housed in one ceiling housing portion 290a are fed to one station at the time of the execution of a marble W.

### Second Modification

In the present embodiment, the shape of the encircling member 1750 of the screw lifter 170a is a cylindrical shape. However, the shape of the encircling member 1750 is not limited to a cylindrical shape. However, the shape of the encircling member 1750 can be appropriately changed. For example, the shape of the encircling member 1750 may be a distorted cylindrical shape. Furthermore, the shape of the encircling member 1750 does not necessarily have a continuous surface, and a plurality of rod-shaped members extending from the first end 1735 of the rotation axis 1734 to the second end 1736 can be arranged at intervals narrower than the diameter of the small balls M1 to form a shape that encircles the supporter 1740 as a whole. In other words, the encircling member 1750 is not necessarily formed from a continuous surface, and it is only necessary to provide a configuration that regulates small balls M1 so as to prevent the small balls M1 from being discharged outward.

### Third Modification

In the present embodiment, the encircling member 1750 encircles only the third portion 1743 of the supporter 1740 (see FIG. 14). However, the encircling member 1750 may encircle also at least either the first portion 1741 or the second portion 1742 of the supporter 1740.

### Fourth Modification

In the present embodiment, the helical supporter 1740 of the screw lifter 170a is located on the side surface 1733 of the rotating body 1730. However, the supporter 1740 is not necessarily located on the side surface 1733. For example, the supporter 1740 may be fixed to a support member provided on the top portion of the rotating body 1730 and a support member provided on the bottom portion thereof, without being provided on the side surface 1733.

### Fifth Modification

In the present embodiment, the screw lifter 170a has the rotating body 1730. However, the rotating body 1730 may be omitted, for example, in a case in which an interval K (see FIG. 16) of the helical supporter 1740 is smaller than the diameter of the small balls M1 and in which the small balls M1 are not in contact with the rotating body 1730. In this case, the supporter 1740 is, for example, rotated about the rotation axis 1734 directly by a motor.

### Sixth Modification

In the present embodiment, the screw lifter 170a has the 12 guides 1760. However, it is sufficient for the number of guides 1760 to be equal to or greater than “one”. The number of transport routes for the small balls M1 can be increased as the number of the guides 1760 increases.

### Seventh Modification

In the present embodiment, the shape of the guides 1760 is a circular column shape. However, the shape of the guides 1760 is not limited to a circular column shape and can be appropriately changed. For example, the shape of the guides 1760 may be a rectangular column shape. It is to be noted that the circular column shape and the rectangular column shape are examples of the rod shape.

### Eighth Modification

In the present embodiment, the supply portion 1780 of the screw lifter 170a has the slope 1781 that allows small balls M1 around the take-in portion 1710 (the first portion 1741) to roll toward the take-in portion 1710. However, the supply portion 1780 is not limited to the configuration having the slope 1781. The supply portion 1780 may instead have a configuration for supplying small balls M1 to the take-in portion 1710 using belt conveyors radially placed around the take-in portion 1710.

### Ninth Modification

In the present embodiment, small balls M1 enter the supply portion 1780 also from the game unit portion 80c located back to back with the game unit portion 80a, in addition to small balls M1 entering from the path 330a of the game unit portion 80a, as shown in FIGS. 13 and 18. However, small balls M1 from the game unit portion 80c do not necessarily enter the supply portion 1780; small balls M1 from the game unit portion 80b or small balls M1 from the game unit portion 80d may enter the supply portion 1780.

### Tenth Modification

In the present embodiment, the screw lifter 170a is used in a game apparatus that uses three-dimensional game objects, such as marbles, that are rollable regardless of orientation of the game objects. However, in a case in which the screw lifter 170a is used in a game apparatus that uses three-dimensional game objects different from those that are rollable regardless of orientation, the screw lifter 170a transports the three-dimensional game objects used in such a game apparatus.

### Eleventh Modification

In the present embodiment, the path 310a is separated from the path 320a, as shown in FIGS. 10 and 11. However, the path 310a and the path 320a may be a single member. Alternatively, a path consisting of the path 310a and the path 320a may consist of three or more angled paths. The path 340a may consist of a plurality of angled paths. Furthermore, it is sufficient for the angles of the paths 310a, 320a, 330a, and 340a to be angles that allow small balls M1 to roll, and the degrees of the angles may be constant or may vary. Each of the paths 310a, 320a, 330a, and 340a may be linear, or a part or the entirety thereof may be curved.

### Twelfth Modification

In the present embodiment, the first hopper 230a is located upstream from both the second hopper 240a and the third hopper 250a. However, the first hopper 230a may be located upstream from the second hopper 240a or the third hopper 250a.

### Thirteenth Modification

In the present embodiment, the entry port 231c as well as the entry port 231a is provided on the path 310a. However, the entry port 231c is not necessarily provided on the path 310a.

### Fourteenth Modification

In the present embodiment, the entry port 241c, in addition to the entry port 241a, is provided on the path 320a, and the entry port 251c, in addition to the entry port 251a, is provided thereon. However, at least one of the entry port 241c or 251c may be omitted from the path 320a.

### Fifteenth Modification

In the present embodiment, the entry port 231a and the entry port 231c face each other, the entry port 241a and the entry port 241c face each other, and the entry port 251a and the entry port 251c face each other. However, the entry port 231a and the entry port 231c do not necessarily face each other; the entry port 241a and the entry port 241c do not necessarily face each other; and the entry port 251a and the entry port 251c do not necessarily face each other. In this case, the regulator 350a is deformed according to the positional relationship with the entry port 231a and the entry port 231c, the regulator 360a is deformed according to the positional relationship with the entry port 241a and the entry port 241c, and the regulators 370a, 380a, and 390a are deformed according to the positional relationship with the entry port 251a and the entry port 251c.

### Sixteenth Modification

In the present embodiment, the entry ports 231a, 231c, 241a, 241c, 251a, and 251c are provided on the sidewalls of the paths. However, at least one of the entry ports 231a, 231c, 241a, 241c, 251a, and 251c may be provided on the bottom of the corresponding path, not on the sidewall of the corresponding path.

### Seventeenth Modification

In the present embodiment, the game field space 410 and the small ball housing space 420 are partitioned with the common partition member 400 as shown in FIG. 20. However, the game field space 410 and the small ball housing space 420 are not necessarily partitioned with the common partition member 400. For example, the bottom of the small ball housing space 420 may be formed from the partition member 400, and the ceiling of the game field space 410 may be formed from a different member.

### Eighteenth Modification

In the present embodiment, the partition member 400 consists of the plate-like members 4010, 4020, and 4030. However, the partition member 400 is not limited to the member consisting of the plate-like members 4010, 4020, and 4030, and that can be appropriately changed. For example, the plate-like member 4030 may be omitted, and one of the ends of the plate-like member 4020 that is closer to the air lifter 180a than is the other end may extend to the second housing member 450. In this case, the shaft 405 is placed at the connection portion between the plate-like member 4020 and the second housing member 450. In this case, for example, a contact portion between the face 4021 and the second housing member 450 is used as the specific portion. The specific portion is not limited to the contact portion 404 between the face 4021 and the face 4031.

### Nineteenth Modification

In the present embodiment, small balls M1 lifted by the air lifter 180a are selectively supplied to one of the ceiling housing portion 290a and the marble-JP chance execution portion 140a as shown in FIG. 9. However, the small balls M1 lifted by the air lifter 180a may be supplied only to the ceiling housing portion 290a. In this case, small balls M1 from another supply portion (for example, the first hopper 230a) are supplied to the marble-JP chance execution portion 140a.

### Twentieth Modification

In the present embodiment, the ceiling housing portion 290a is used in the game apparatus 10 that uses three-dimensional game objects, such as marbles, that are rollable regardless of orientation of the game objects. However, when used in a game apparatus that uses three-dimensional game objects that are different from the three-dimensional game objects that are rollable regardless of orientation, the ceiling housing portion 290a houses the three-dimensional game objects used in such a game apparatus.

### Twenty-First Modification

The station 100a may have a “medal mode” and a “credit mode” as operation modes. In this case, in the medal mode, small balls M1 are fed to the game field 110a in response to input of token coins into the station 100a as in the present embodiment. The station 100a pays out a predetermined number of token coins from the payout port Ma each time small balls M1 fall from the front edge 116. Meanwhile, in the credit mode, credits are accumulated in the station 100a in response to an input of a medal into the station 100a. The player operates a feeding button (not shown) to feed a small ball M1 to the game field 110a in exchange for spending of predetermined credits. The station 100a increases credits each time a small ball M1 falls from the front edge 116.

### Twenty-Second Modification

It is sufficient for the game to be a game in which three-dimensional game objects such as small balls M1 are used. The pusher game is an example of the game. However, the game is not limited to the pusher game.

### C. Appendix

For example, the present invention is understood as follows based on the above descriptions. In the following descriptions, reference signs in the drawings are denoted in parentheses for convenience in order to facilitate understanding of each aspect, but the present invention is not limited to the aspects illustrated in the drawings.

### Appendix a1

A conveyor device (170a) according to one aspect of the present invention includes: a supporter (1740) configured to support a three-dimensional game object (M1), in which the supporter (1740) is rotatable about a rotation axis (1734) having a first end (1735) and a second end (1736), with the supporter (1740) extending from the first end (1735) to the second end (1736) in a helical manner relative to the rotation axis (1734), and in which the supporter (1740) includes a first portion (1741) on the first end (1735) of the rotation axis (1734), a second portion (1742) on the second end (1736) of the rotation axis (1734), and a third portion (1743) between the first portion (1741) and the second portion (1742); an encircling member (1750) that encircles at least the third portion (1743) of the supporter (1740); and at least one guide (1760) for the three-dimensional game object (M1) to move from the first end (1735) to the second end (1736) along with the rotation of the supporter (1740). The at least one guide (1760) is configured such that the guide (1760) in coordination with the supporter (1740) and the encircling member (1750) supports the three-dimensional game object (M1) when the three-dimensional game object (M1) moves from the first end (1735) to the second end (1736), and the at least one guide (1760) extends from the first end (1735) to the second end (1736) within a gap between the supporter (1740) and the encircling member (1750).

According to this aspect, the three-dimensional game object (M1) is supported by the supporter (1740), the encircling member (1750), and the guide (1760) and is moved while being guided by the guide (1760) along with the rotation of the supporter (1740). Thus, one guide (1760) is a part of one transport route for a three-dimensional game object (M1). Accordingly, one guide (1760) is required for one transport route for a three-dimensional game object (M1). Therefore, a number of guides (1760) greater than the number of transport routes is not required, and increase in the number of the guides (1760) can be suppressed.

The three-dimensional game object (M1) may be rollable regardless of orientation of the game object (M1), as a spherical object or a substantially spherical object, or are not necessarily rollable regardless of orientation.

The rotation axis (1734) may be an axis penetrating through a rotating body (1730), or may be an axis independent of the rotating body (1730), for example, in a case in which the rotating body (1730) is omitted.

The supporter (1740) may be fixed to a side surface (1733) of the rotating body (1730) or but need not necessarily be fixed to the side surface (1733).

The shape of the encircling member (1750) may be cylindrical, but is not necessarily cylindrical. The entirety or a part of the encircling member (1750) may be formed of a transparent material.

The shape of the guide (1760) can be a circular column shape or a rectangular column shape, but is not necessarily a circular column shape or a rectangular column shape. The circular column shape or the rectangular column shape is included in a rod shape.

### Appendix a2

In a conveyor device (170a) according to another aspect, the encircling member (1750) is configured to not encircle the first portion (1741), and the supporter (1740) is configured to take in the three-dimensional game object (M1) through the first portion (1741), in the conveyor device described in the appendix a1.

With the conveyor device (170a) according to the appendix a2, the three-dimensional game object (M1) can be taken in through the first portion (1741) from 360 degrees in any direction around the first portion (1741).

### Appendix a3

In a conveyor device (170a) according to another aspect, the guide (1760) has a portion on the first end (1735) of the rotation axis (1734), with the portion configured to be not encircled by the encircling member (1750), and the guide (1760) is configured to serve as a guide for the three-dimensional game object (M1) to be taken in, in the conveyor device described in the appendix a2.

With the conveyor device (170a) according to the appendix a3, the guide (1760) can be used also as a take-in member for the three-dimensional game object (M1).

### Appendix a4

A conveyor device (170a), according to another aspect, further includes a supply portion (1780) configured to supply to the first portion (1741) a three-dimensional game object (M1) that is present near the first portion (1741), in the conveyor device described in the appendix a2 or a3.

With the conveyor device (170a) according to the appendix a4, the take-in efficiency for the three-dimensional game object (M1) through the first portion (1741) can be enhanced as compared to a case in which the supply portion (1780) is not provided.

The supply portion (1780) may include a slope (1781) that is at an angle that allows the three-dimensional game object (M1) present near the first portion (1741) to roll toward the first portion (1741), or may include no slope. For example, a configuration in which the three-dimensional game object (M1) is supplied to the first portion (1741) using belt conveyors arrayed radially around the first portion (1741) may be used as the supply portion (1780).

### Appendix a5

In a conveyor device (170a) according to another aspect, the three-dimensional game object (M1) is rollable regardless of orientation of the game object (M1), and the supply portion (1780) includes a slope (1781) that is at an angle that allows the three-dimensional game object (M1) present near the first portion (1741) to roll toward the first portion (1741), in the conveyor device described in the appendix a4.

With the conveyor device (170a) according to the appendix a5, the three-dimensional game object (M1) present near the first portion (1741) is enabled to roll toward the first portion (1741) with own weight of the three-dimensional game object (M1). Therefore, the transport efficiency can be increased as compared to a case in which the three-dimensional game object (M1) is supplied to the first portion (1741) using power.

The three-dimensional game object (M1) that is rollable regardless of orientation of the game object (M1) may be a spherical object (for example, a marble or a ball), or may be a substantially spherical object (for example, a polyhedron).

### Appendix a6

In a conveyor device (170a) according to another aspect, the encircling member (1750) is configured to not encircle the second portion (1742), and the supporter (1740) is configured to discharge the three-dimensional game object (M1) through the second portion (1742), in the conveyor device described in any one of the appendices a1 to a5.

With the conveyor device (170a) according to the appendix a6, the three-dimensional game object (M1) can be discharged in 360 degrees in any direction around the second portion (1742).

### Appendix a7

In a conveyor device (170a) according to another aspect, a part of the second portion (1742) is provided with an ejection portion (1790) configured to eject the three-dimensional game object (M1), in the conveyor device described in the appendix a6.

With the conveyor device (170a) according to the appendix a7, the three-dimensional game object (M1) is ejected by the ejection portion (1790) when reaching the second portion (1742). Therefore, it is possible to prevent the three-dimensional game object (M1) from remaining in the second portion (1742).

### Appendix a8

In a conveyor device (170a) according to another aspect, the supply portion (1780) is configured to supply to the first portion (1741) three-dimensional game objects (M1) respectively collected from a plurality of game unit portions (80a, 80c) each configured to use the three-dimensional game object (M1), in the conveyor device described in any one of the appendices a1 to a7.

With the conveyor device (170a) according to the appendix a8, the conveyor device (170a) can be shared by the game unit portions (80a and 80c).

The number of the game unit portions (80a and 80c) that share the conveyor device (170a) is not limited to “two” and may be “three” or more.

### Appendix b

Pusher game apparatuses that move token coins fed onto a game field are conventionally known (see Japanese Patent Application Laid-Open Publication No. 2013-99632). A lift hopper or the like that moves the token coins along a rail is used in the pusher game apparatuses to transport the token coins to a feeding portion.

On the other hand, three-dimensional game objects (for example, spherical three-dimensional game objects) rollable regardless of orientation of the game objects can be used instead of the token coins in a pusher game. In this case, it is preferable to use a conveyor device suitable for the three-dimensional game objects, instead of the lift hopper used to transport the token coins. Preferred aspects (appendices b) of the present invention have been achieved in view of circumstances described above, and one of the problems to be solved thereby is to provide a technique that enables efficient transport of three-dimensional game objects in a game apparatus.

### Appendix b1

A conveyor device (20) for a game apparatus according to one aspect of the present invention is a conveyor device (20) used to transport a three-dimensional game object (M1) in a game apparatus (10 or 100a), the conveyor device (20) including: a path (310a, 320a) that is at an angle that allows a three-dimensional game object (M1) rollable regardless of orientation of the game object (M1) to roll; a first utilizer (230a or 240a) configured to utilize a three-dimensional game object (M1) entering from a first entry port (231a or 241a) located on the path (310a, 320a); and a second utilizer (240a or 250a) configured to utilize a three-dimensional game object (M1) entering from a second entry port (241a or 251a) located on the path (310a, 320a). One (231a or 241a) of the first entry port (231a or 241a) and the second entry port (241a or 251a) is located upstream of the path (310a, 320a), and the other one (241a or 251a) thereof is located downstream of the path (310a, 320a).

According to this aspect, the three-dimensional game object (M1) rolls due to the angle of the path (310a, 320a) and enters the first utilizer (230a or 240a) or the second utilizer (240a or 250a). Therefore, the three-dimensional game object (M1) can be more efficiently transported as compared to a case in which the three-dimensional game object (M1) is transported to the first utilizer (230a or 240a) or the second utilizer (240a or 250a) using power on the path (310a, 320a).

Furthermore, one of the first entry port (231a or 241a) and the second entry port (241a or 251a) is located upstream of the path (310a, 320a) and the other one (241a or 251a) thereof is located downstream of the path (310a, 320a). Therefore, three-dimensional game objects that have not entered one (231a or 241a) of the entry ports can be received by the other (241a or 251a). Accordingly, three-dimensional game objects (M1) rolling on the path (310a, 320a) are likely to enter either the first entry port (231a or 241a) or the second entry port (241a or 251a).

The game apparatus (10 or 100a) may be a business-use game apparatus, a home-use game apparatus, or a terminal device.

A game at the game apparatus (10 or 100a) may be playable with game currency, such as token coins (medals), credits, or points. The game currency such as token coins, credits, or points may be exchangeable for real money or may not be exchangeable for real money. A game at the game apparatus (10 or 100a) may be playable with actual money.

In the game apparatus (10 or 100a), elements (play price elements) that are received from a player to play a game and elements (reward elements) that are used as a reward to the player may be the same type of elements (for example, the play price elements and the reward elements may both be token coins), or may be different types of elements (for example, the play price elements may be token coins and the reward elements may be vouchers).

It is sufficient for the game to be a game that uses three-dimensional game objects (M1). A pusher game in which marbles or token coins are used is an example of the game. However, the game is not limited to the pusher game.

The three-dimensional game object (M1) that is rollable regardless of orientation of the game object (M1) may be a spherical object (for example, a marble or a ball), or may be a substantially spherical object (for example, a polyhedron).

The path (310a, 320a) may consist of a plurality of paths or may consist of a single path.

It is sufficient for the angle of the path (310a, 320a) to allow the three-dimensional game object (M1) to roll, and the degrees of the angle may be constant or may vary. Furthermore, the path (310a, 320a) may be linear or curved.

The manner of utilization of the three-dimensional game object (M1) by the first utilizer (230a or 240a) and the manner of utilization of the three-dimensional game object (M1) by the second utilizer (240a or 250a) may be different from each other or may be substantially the same as each other.

The first entry port (231a or 241a) may be provided on a sidewall (311a or 321a) of the path (310a, 320a), or may be provided on the bottom of the path (310a, 320a). Similarly, the second entry port (241a or 251a) may be provided on a sidewall (311a or 321a) of the path (310a, 320a) or may be provided on the bottom of the path (310a, 320a).

### Appendix b2

A game apparatus (10 or 100a) according to one aspect of the present invention includes the conveyor device (170a) for the game apparatus described in the appendix b1 and provides a game that progresses in accordance with movement of the three-dimensional game object (M1).

According to this aspect, the three-dimensional game object (M1) can be efficiently transported in the game apparatus (10 or 100a) that provides a game progressing in accordance with movement of the tree-dimensional game object (M1).

### Appendix b3

In a game apparatus (10 or 100a) according to another aspect, at least one of the first utilizer (230a or 240a) and the second utilizer (240a or 250a) feeds the three-dimensional game object (M1) to a game field (110a), in the game apparatus described in the appendix b2.

With the game apparatus (10 or 100a) according to the appendix b3, the three-dimensional game object (M1) can be efficiently transported in a game apparatus that feeds the three-dimensional game object (M1) to the game field (110a).

### Appendix b4

A game apparatus (10 or 100a) according to another aspect includes a lottery portion (120a or 130a) that performs a lottery using the three-dimensional game object (M1), in the game apparatus described in the appendix b3, in which one of the first utilizer (230a) and the second utilizer (240a or 250a) feeds the three-dimensional game object (M1) to the lottery portion (120a or 130a) and the other one (240a or 250a) thereof feeds the three-dimensional game object (M1) to the game field (110a).

With the game apparatus (10 or 100a) according to the appendix b4, the three-dimensional game object (M1) can be efficiently transported in the game apparatus (10 or 100a) that feeds the three-dimensional game object (M1) to the lottery portion (120a or 130a) or the game field (110a).

### Appendix b5

In a game apparatus (10 or 100a) according to another aspect, a regulator (350a, 360a, 370a, 380a, or 390a) configured to regulate a movement direction of the three-dimensional game object (M1) to guide the three-dimensional game object (M1) to at least one of the first entry port (231a or 241a) and the second entry port (241a or 251a) is located on the path (310a, 320a), in the game apparatus described in any of the appendices b2 to b4.

With the game apparatus (10 or 100a) according to appendix b5, the three-dimensional game object (M1) is likely to enter at least one of the first entry port (231a or 241a) and the second entry port (241a or 251a).

### Appendix b6

A game apparatus (10 or 100a) according to another aspect includes a feedback conveyor (30) configured to transport the three-dimensional game object (M1) having been used in the first utilizer (240a) or/and the second utilizer (250a) to a position on the path (310a, 320a) upstream from the first entry port (241a) and the second entry port (251a) located on the path (310a, 320a), in the game apparatus described in any of the appendices b2 to b5.

With the game apparatus (10 or 100a) according to the appendix b6, the feedback conveyor (30) transports the three-dimensional game object (M1), thereby enabling the three-dimensional game object (M1) to be circulated among the path (310a, 320a), the first utilizer (240a) or the second utilizer (250a), and the feedback conveyor (30).

### Appendix b7

A game apparatus (10) according to another aspect includes two or more conveyor unit portions (90) each including a combination of the conveyor device (20) for a game apparatus and the feedback conveyor (30), in the game apparatus described in the appendix b6, in which one of the conveyor unit portions (90) includes a game object sorter (260a) configured to sort at least a part of the three-dimensional game objects (M1) having passed through the path (310a, 320a) without entering the first utilizer (240a) or the second utilizer (250a), into the feedback conveyor (30) of the other one of the conveyor unit portions (90). In this case, “a part of” the three-dimensional game objects (M1) includes “one or more” three-dimensional game objects (M1).

With the game apparatus (10) according to the appendix b7, three-dimensional game objects (M1) that have entered neither the first utilizer (230a or 240a) nor the second utilizer (240a or 250a) in one of the conveyor unit portions (90), for example, because the first utilizer (230a or 240a) and the second utilizer (240a or 250a) are filled with three-dimensional game objects (M1), can be sorted into the other conveyor unit portion (90). Therefore, even if imbalance in the numbers of three-dimensional game objects (M1) occurs between one of the conveyor unit portions (90) and the other conveyor unit portion (90), the imbalance can be reduced.

### Appendix b8

A game apparatus (100a) according to another aspect includes a sorter (260a) configured to sort at least a part of three-dimensional game objects (M1) that have passed through the path (310a, 320a) without entering the first utilizer (230a or 240a) or the second utilizer (240a or 250a) into another game apparatus (100b) that utilizes the three-dimensional game object (M1), in the game apparatus described in any of the appendices b2 to b5. In this case, “a part of” the three-dimensional game objects (M1) includes “one or more” three-dimensional game objects (M1).

With the game apparatus (100a) according to the appendix b8, three-dimensional game objects (M1) that have entered neither the first utilizer (230a or 240a) nor the second utilizer (240a or 250a), for example, because the first utilizer (230a or 240a) and the second utilizer (240a or 250a) are filled with three-dimensional game objects (M1), can be sorted into another game apparatus (100b). Therefore, even if imbalances in the number of three-dimensional game objects (M1) occurs between the game apparatus (100a) and the game apparatus (100b), the imbalance can be reduced.

### Appendix b9

In a game apparatus (100a) according to another aspect, the feedback conveyor (30) is configured to receive entry of the three-dimensional game object (M1) from another game apparatus (100b) that utilizes the three-dimensional game object (M1) and to transport the received three-dimensional game object (M1) to a position on the path (310a, 320a) upstream from the first entry port (231a or 241a) and the second entry port (241a or 251a) located on the path (310a, 320a), in the game apparatus described in the appendix b6.

With the game apparatus (100a) according to the appendix b9, for example, three-dimensional game objects (M1) can be supplemented from another game apparatus (100b).

### Appendix b10

A game apparatus (10) according to another aspect of the present invention includes two or more game unit portions (80a or 80c) each including a path (320a) that is at an angle that allows a three-dimensional game object (M1) that is rollable regardless of orientation of the game object (M1) to roll, and a utilizer (240a or 240c) configured to utilize a three-dimensional game object (M1) entering from an entry port (241a or 241c) located on the path (320a), in which there is located on the path (320a) a regulator (360a) configured to regulate a movement direction of the three-dimensional game object (M1) to guide the three-dimensional game object (M1) to any of entry ports (241a, 241c) of the utilizers (240a, 240c) of one (80a) of the game unit portions and the other one (80c) of the game unit portions.

With the game apparatus (10) according to this aspect, three-dimensional game objects (M1) are likely to enter at least either the entry port (241a) of one game unit portion (80a) or the entry port (241c) of the other game unit portion (80c).

### Appendix c

Pusher game apparatuses that move token coins fed onto a game field are known (see Japanese Patent Application Laid-Open Publication No. 2013-99632). In the pusher game apparatuses, token coins are transported to a feeding portion and then are fed to the game field from the feeding portion.

An upper space of a game field housing portion that houses a game field has not been effectively used in a conventional game apparatus, such as a pusher game apparatus. Preferred aspects (appendices c) of the present invention have been achieved in view of circumstances described above, and one of the problems to be solved thereby is to provide a technique that effectively uses an upper space of a game field housing portion that houses a game field.

### Appendix c1

A game apparatus (10) according to one aspect of the present invention includes: a game field housing portion (430) configured to house game fields (110a, 110b, 110c, and 110d); a game object housing portion (290a) located above the game field housing portion (430) and configured to house a three-dimensional game object (M1); and a feeding portion (470) configured to feed the three-dimensional game object (M1) housed in the game object housing portion (290a) into a game field space (410) in which the game field housing portion (430) houses the game fields (110a, 110b, 110c, and 110d).

According to this aspect, because the game object housing portion (290a) is located above the game field housing portion (430), a space above the game field housing space (430) can be effectively used.

The game apparatus (10) may be a business-use game apparatus, a home-use game apparatus, or a terminal device.

A game in the game apparatus (10) may be playable with game currency, such as token coins (medals), credits, or points. The game currency such as token coins, credits, or points may be exchangeable for real money or may not be exchangeable for real money. A game in the game apparatus (10 or 100a) may be playable with real money.

In the game apparatus (10), elements (hereinafter, also referred to as “play price elements”) that are received from a player to play a game, and elements (hereinafter, “reward elements”) that are used as a reward for the player, may be of the same type of elements (for example, the play price elements and the reward elements may both be token coins), or may be of different types of elements (for example, the play price elements may be token coins and the reward elements may be vouchers).

It is sufficient for the game to be a game in which three-dimensional game objects (M1) are used. A pusher game in which marbles or token coins are used is an example of the game, but the game is not limited to the pusher game.

A game object housing space (420) in which the game object housing portion (290a) houses the three-dimensional game object (M1), and the game field space (410) may be partitioned directly by a partition member (400), but are not necessarily partitioned directly by the partition member (400). For example, the bottom of the game object housing portion (420) may be formed of the partition member (400) and the ceiling of the game field space (410) may be formed of a different member.

The three-dimensional game object (M1) may be rollable regardless of orientation of the game object (M1), as a spherical object or a substantially spherical object, but is not necessarily rollable regardless of orientation.

### Appendix c2

A game apparatus (10) according to another aspect, a game object housing space (420) in which the game object housing portion (290a) houses the three-dimensional game object (M1) and the game field space (410) are partitioned by a first member (400), in the game apparatus described in the appendix c1.

With the game apparatus (10) according to the appendix c2, the first member (400) can be used as the bottom of the game object housing space (420) and the ceiling of the game field space (410). Therefore, the configuration can be simplified as compared to a case in which the bottom of the game object housing space (420) and the ceiling of the game field space (410) are constituted of different members.

A part or the entirety of the first member (400) may be formed of a transparent material, or the entirety of the first member (400) may be formed of a nontransparent material.

### Appendix c3

In a game apparatus (10) according to another aspect, a part or the entirety of the first member (400) is formed of a transparent material in the game apparatus described in the appendix c2.

With the game apparatus (10) according to the appendix c3, three-dimensional game objects (M1) housed in the game object housing space (420) can be presented to the player and a sense of amusement can be given to the player.

### Appendix c4

In a game apparatus (10) according to another aspect, the three-dimensional game object (M1) is rollable regardless of orientation of the game object (M1), and a face (4011, 4021, 4031) of the first member (400), with the face facing the game object housing space, includes a slope (4011, 4021, 4031) that is at an angle that allows the three-dimensional game object (M1) to roll toward a specific portion (404) of the face (4011, 4021, 4031) facing the game object housing space, in the game apparatus described in the appendix c2 or c3.

With the game apparatus (10) according to the appendix c4, three-dimensional game objects (M1) are moved to the specific portion (404) by rolling, and therefore three-dimensional game objects (M1) can be more efficiently collected at the specific portion (404), for example, as compared to a case in which three-dimensional game objects (M1) are moved by power.

The three-dimensional game object (M1) that is rollable regardless of orientation of the game object (M1) may be a spherical object (for example, a marble or a ball) or may be a substantially spherical object (for example, a polyhedron).

The specific portion (404) may be located at any position of the face (4011, 4021, 4031) facing the game object housing space.

### Appendix c5

A game apparatus (10) according to another aspect includes a supply path (460) for supplying the three-dimensional game object (M1) housed in the game object housing portion (420) to the game field space (410), in the game apparatus described in the appendix c4, in which the feeding portion (470) changes at least a part (4021) of the slope (4011, 4021, 4031) of the first member (400) from an angle that allows the three-dimensional game object (M1) to roll toward the specific portion (404), to an angle that allows the three-dimensional game object (M1) to roll toward the supply path (460), in a case in which feeding the three-dimensional game object (M1) housed in the game object housing portion (420) to the game field space (410).

With the game apparatus (10) according to the appendix c5, three-dimensional game objects (M1) are moved to the supply path (460) by rolling, and therefore three-dimensional game objects (M1) can be more efficiently moved to the supply path (460), for example, as compared to a case in which three-dimensional game objects (M1) are moved by power.

### Appendix c6

A game apparatus (10) according to another aspect further includes: a game object conveyor (40) configured to transport the three-dimensional game object (M1) in the game field space (410) through a predetermined transport path (60, 70); a game execution portion (50) that performs a game in which the three-dimensional game object (M1) is used in the game field space (410); and a switcher (280a) configured to switch the predetermined transport path (60, 70) between a first path (60) leading to the game object housing portion and a second path (70) leading to the game execution portion (50), in the game apparatus described in any of the appendices c1 to c5.

With the game apparatus (10) according to the appendix c6, the game object conveyor (40) can transport both three-dimensional game objects (M1) to be transported to the first path (60) and three-dimensional game objects (M1) to be transported to the second path (70).

### Appendix d

Pusher game apparatuses that move token coins fed onto a game field are conventionally known (see Japanese Patent Application Laid-Open Publication No. 2013-99632). A lift hopper or the like that moves the token coins along a rail is used in the pusher game apparatuses to transport the token coins to a feeding portion.

Three-dimensional game objects (for example, spherical three-dimensional objects) rollable regardless of orientation of the game objects can be used instead of the token coins in a pusher game. In this case, it is preferable to use a conveyor device suitable for the three-dimensional game objects, in place of the lift hopper used to transport the token coins. Preferred aspects (appendices d) of the present invention have been achieved in view of circumstances described above, and one of the problems to be solved thereby is to provide a technique that efficiently transports three-dimensional game objects in a game apparatus.

### Appendix d1

A game apparatus (10) according to one aspect of the present invention includes: a first path (310a, 320a) that is at an angle that allows a three-dimensional game object (M1) that is rollable regardless of orientation of the game object (M1) to roll; a feeding portion (240a, 250a) configured to feed a three-dimensional game object (M1) entering from an entry port (241a, 251a) located on the first path (310a, 320a) into a game field (110a); a second path (340a) that is at an angle that allows a three-dimensional game object (M1) that enters from the game field (110a) to roll; and a conveyor (170a) configured to transport a three-dimensional game object (M1) that enters from the second path (340a) to a position on the first path (310a, 320a) upstream from the entry port (241a, 251a) located on the first path (310a, 320a).

According to this aspect, when the conveyor (170a) transports a three-dimensional game object (M1) to the first path (310a, 320a), the three-dimensional game object (M1) rolls due to the angle of the first path (310a, 320a) to enter the feeding portion (240a, 250a), then passes through the game field (110a) to enter the second path (340a), and rolls due to the angle of the second path (340a) to enter the conveyor (170a). Therefore, by transporting a three-dimensional game object (M1) to the first path (310a, 320a) through the conveyor (170a) only, the three-dimensional game object (M1) is allowed to circulate on a route including the first path (310a, 320a), the feeding portion (240a or 250a), the game field (110a), the second path (340a), and the conveyor (170a). Accordingly, three-dimensional game objects (M1) can be more efficiently transported as compared to a case in which three-dimensional game objects (M1) are transported by power on the first path (310a, 320a) and the second path (340a).

The game apparatus (10) may be a business-use game apparatus, a home-use game apparatus, or a terminal device.

A game in the game apparatus (10) may be playable with game currency, such as token coins (medals), credits, or points. The game currency such as token coins, credits, or points may be exchangeable for real money or may not be exchangeable for real money. The game apparatus (10) may be playable with real money.

In the game apparatus (10), elements (play price elements) that are received from a player to play a game and elements (reward elements) that are used as a reward for the player may be the same type of elements (for example, the play price elements and the reward elements may both be token coins), or may be different types of elements (for example, the play price elements may be token coins and the reward elements may be vouchers).

It is sufficient for the game to be a game in which three-dimensional game objects (M1) are used. A pusher game in which marbles or token coins are used is an example of the game. However, the game is not limited to the pusher game.

The three-dimensional game object (M1) that is rollable regardless of orientation of the game object (M1) may be a spherical object (for example, a marble or a ball), or may be a substantially spherical object (for example, a polyhedron).

Each of the first path (310a, 320a) and the second path (340a) may consist of a plurality of paths or may consist of a single path.

It is sufficient for each of the angle of the first path (310a, 320a) and the angle of the second path (340a) to allow the three-dimensional game object (M1) to roll, and the degrees of the angle may be constant or may vary. Furthermore, each of the first path (310a, 320a) and the second path (340a) may be linear or curved.

The entry port (241a or 251a) may be provided on a sidewall (311a or 321a) of the first path (310a, 320a), or may be provided on the bottom of the first path (310a, 320a).

### Appendix d2

In a game apparatus (10) according to another aspect, the first path (310a, 320a) is at an angle that allows the three-dimensional game object (M1) to roll horizontally from one end to the other end of the first path, and the second path (340a) is at an angle that allows the three-dimensional game object (M1) to roll in a reverse horizontal direction, in the game apparatus described in the appendix d1.

With the game apparatus (10) according to the appendix d2, the most upstream part of the first path (310a, 320a) and the most downstream part of the second path (340a) can be arranged in the same position horizontally. Therefore, the conveyor (170a) can transport three-dimensional game objects (M1) in the same position horizontally. Accordingly, the horizontal length of the conveyor (170a) can be shortened, for example, as compared to a case in which the conveyor (170a) transports three-dimensional game objects (M1) from one to the other of two positions that are different horizontally.

### Appendix d3

In a game apparatus (10) according to another aspect, the second path (340a) is located substantially vertically below the first path (310a, 320a) in the game apparatus described in the appendix d2.

With the game apparatus (10) according to the appendix d3, the positions of the first path (310a, 320a) and the second path (340a) on the horizontal axis can be substantially aligned.

To be located substantially vertically below the first path (310a, 320a) includes to be located vertically below the first path (310a, 320a). A state in which the second path (340a) is located substantially vertically below the first path (310a, 320a) includes a state in which the second path (340a) overlaps with a part of the first path (310a and 320a) when the first path (310a, 320a) and the second path (340a) are seen in a planar view in a vertical direction.

### Appendix d4

In a game apparatus (10) according to another aspect, the conveyor (170a) transports a three-dimensional game object (M1) entering from the second path (340a) substantially vertically upward to the first path (310a, 320a) in the game apparatus described in the appendix d3.

With the game apparatus (10) according to the appendix d4, the transport route of three-dimensional game objects (M1) transported by the conveyor (170a) can be shortened.

“Substantially vertical” indicates that the inclination relative to the vertical s is within a predetermined angle. It is sufficient for the predetermined angle to have a range in which inclination at the predetermined angle relative to the vertical can be regarded as being vertical.

### Appendix d5

A game apparatus (10) according to another aspect includes a plurality of game unit portions (80a, 80c) each having the feeding portion (240a, 250a), in which the first path (310a, 320a) or/and the second path (340a) is/are shared by at least two (80a, 80c) of the plurality of game unit portions (80a, 80c), in the game apparatus described in any of the appendices d1 to d4.

With the game apparatus (10) according to the appendix d5, the first path (310a, 320a) or/and the second path (340a) is/are shared by at least two (80a, 80c) of the game unit portions (80a, 80c). Therefore, the configuration can be simplified compared to a case in which the first path (310a, 320a) and the second path (340a) are used for each of the game unit portions (80a, 80c), without the first path (310a, 320a) or/and the second path (340a) being shared.

### Appendix d6

In a game apparatus (10) according to another aspect, the first path (310a, 320a) or/and the second path (340a) is/are located between two game unit portions (80a, 80c) adjacent to each other and is/are shared by the two game unit portions (80a, 80c), in the game apparatus described in the appendix d5.

With the game apparatus (10) according to the appendix d6, the distances between the first path (310a, 320) or/and the second path (340a), and the two game unit portions (80a, 80c) can be shortened.

### Appendix d7

In a game apparatus (10) according to another aspect, at least a part of the three-dimensional game objects (M1) that has not entered the entry port (241a or 251a) on the first path (310a, 320a) enter the second path (340a), in the game apparatus described in any of the appendices d1 to d3. In this case, “a part of” the three-dimensional game objects (M1) includes “one or more” three-dimensional game objects (M1).

With the game apparatus (10) according to the appendix d7, three-dimensional game objects (M1) that have not entered the feeding portion (240a or 250a), for example, because the feeding portion (240a or 250a) is filled with three-dimensional game objects, (M1) can also circulate on a route including the first path (310a, 320a), the feeding portion (240a or 250a), the game field (110a), the second path (340a), and the conveyor (170a).

### Appendix e

A game apparatus having a plurality of unit portions (also referred to as “stations”) in which a plurality of players can play games using game objects such as token coins, respectively, is known (see Japanese Patent Application Laid-Open Publication No. 2017-23481).

In the game apparatus described above, for example, when there is imbalance in the numbers of game objects between one unit portion and another unit portion among the unit portions, an administrator needs to adjust the numbers of game objects in the unit portions. Preferred aspects (appendices e) of the present invention have been achieved in view of circumstances described above, and one of the problems to be solved thereby is to provide a technique that reduces operations performed by the administrator to adjust the numbers of game objects in the unit portions.

### Appendix e1

A game apparatus (10) according to one aspect of the present invention is a game apparatus (10) including a plurality of unit portions (100a, 100b, 100c, 100d) in which a plurality of players can play games, respectively, in which one unit portion (100a) includes a game object receiver (343a) configured to receive game objects (M1) supplied from another unit portion (100b), a game object utilizer (240a, 250a) configured to utilize in a game at least a part of the game objects (M1) received by the game object receiver (343a), and a game object supply portion (322a) configured to supply at least a part of the game objects (M1) received by the game object receiver (343a) to the another unit portion (100b). In this case, “a part of” game objects (M1) includes “one or more” game objects (M1).

According to this aspect, game objects can move between one unit portion (100a) and another unit portion (100b). Therefore, operations performed by the administrator of the game apparatus (10) to adjust the numbers of game objects in the unit portions (100a, 100b) can be reduced.

The game apparatus (10) may be a business-use game apparatus, a home-use game apparatus, or a terminal device.

A game in the game apparatus (10) may be playable with game currency, such as token coins (medals), credits, or points. The game currency such as token coins, credits, or points may be unexchangeable for real money or may be exchangeable for real money. The game apparatus (10) may be playable with actual money.

In the game apparatus (10), elements (play price elements) that are received from a player to play a game and elements (reward elements) that are used as a reward for the player may be the same type of elements (for example, the play value elements and the reward elements may both be token coins), or may be different types of elements (for example, the play price elements may be token coins and the reward elements may be vouchers).

It is sufficient for the game to be a game in which game objects (M1) are used. A pusher game in which marbles or token coins are used is an example of the game. However, the game is not limited to the pusher game.

The game objects (M1) may be rollable regardless of orientation of the game objects (M1), as spherical objects or substantially spherical objects, but are not necessarily rollable regardless of orientation.

### Appendix e2

In a game apparatus (10) according to another aspect, the game object supply portion (322a) supplies to the another unit portion (100b) at least a part of the game objects (M1) that have not been utilized by the game object utilizer (240a, 250a) among the game objects (M1) received by the game object receiver (343a), in the game apparatus described in the appendix e1.

With the game apparatus according to the appendix e2, game objects (M1) not having been utilized by one unit portion (100a), that is, game objects (M1) left over in one unit portion (100a) can be supplied to another unit portion (100b). Therefore, excessive supply of game objects (M1) from one unit portion (100a) to another unit portion (100b) can be suppressed.

### Appendix e3

In a game apparatus (10) according to another aspect, the game objects (M1) are rollable regardless of orientation of the game objects (M1), the one unit portion (100a) has a first path (320a) that is at an angle that allows the game objects (M1) to roll, the game object utilizer (240a, 250a) utilizes game objects (M1) entering from an entry port (241a, 251a) located on the first path (320a), and the game object supply portion (322a) is located downstream from the entry port (241a, 251a) on the first path (320a) and supplies to the another unit portion (100b) at least a part of game objects (M1) that have not entered the entry port (241a, 251a), in the game apparatus described in the appendix e2.

With the game apparatus (10) according to the appendix e3, game objects (M1) are transported by rolling due to the angle, and therefore transport can be performed more efficiently compared to a case in which game objects (M1) are transported by power.

The game objects (M1) that are rollable regardless of orientation of the game objects (M1) may be spherical objects (for example, marbles or balls) or may be substantially spherical objects (for example, polyhedrons).

It is sufficient for the angle of the first path (320a) to allow game objects (M1) to roll, and the degrees of the angle may be constant or may vary. Furthermore, the path (320a) may be linear or curved.

The entry port (241a or 251a) may be provided on a sidewall (321a) of the first path (320a), or may be provided on the bottom of the first path (320a).

### Appendix e4

In a game apparatus (10) according to another aspect, the game object receiver (343a) receives at least a part of game objects (M1) that have not been utilized by the another unit portion (100b) from among the game objects (M1) supplied by the game object supply portion (322a) to the another unit portion (100b), in the game apparatus described in any of the appendices e1 to e3.

With the game apparatus according to the appendix e4, game objects (M1) that having not been utilized by another unit portion (100b), that is, game objects (M1) left over in another unit portion (100b), can be received by one unit portion (100a). Therefore, excessive supply of game objects (M1) from another unit portion (100b) to one unit portion (100a) can be suppressed.

### Appendix e5

In a game apparatus (10) according to another aspect, the game objects (M1) are rollable regardless of orientation of the game objects (M1), the one unit portion (100a) has a second path (340a) that is at an angle that allows the game objects (M1) received by the game object receiver (343a) to roll, and the second path (340a) also receives game objects (M1) having been utilized by the game object utilizer (240a, 250a), in the game apparatus described in any of the appendices e1 to e4.

With the game apparatus (10) according to the appendix e5, the second path (340a) transports game objects (M1) by rolling the game objects (M1) due to the angle and therefore the transport can be performed more efficiently than in a case in which game objects (M1) are transported by power. Furthermore, the second path (340a) can also be used as a receiver that also receives game objects (M1) that have been utilized by the game object utilizer (240a, 250a).

It is sufficient for the angle of the second path (340a) to allow game objects (M1) to roll, and the degrees of the angle may be constant or may vary. Furthermore, the second path (340a) may be linear or curved.

### Appendix e6

A game apparatus (100a) according to another aspect of the present invention is a game apparatus (100a) that uses game objects (M1) shared by another game apparatus (100b), and includes: a shared game object receiver (343a) configured to receive game objects (M1) supplied from the another game apparatus (100b); a shared game object utilizer (240a, 250a) configured to utilize in a game at least a part of game objects (M1) received by the shared game object receiver (343a); and a shared game object supply portion (322a) configured to supply to the another game apparatus (100b) at least a part of the game objects (M1) received by the shared game object receiver (343a). In this case, “a part of” game objects (M1) includes “one or more” game objects (M1).

According to this aspect, game objects (M1) can move between the game apparatus (100a) and another game apparatus (100b). Therefore, operations performed by an administrator to adjust the numbers of game objects (M1) in the game apparatus (100a) and another game apparatus (100b) can be reduced.

The game apparatus (100a) and another game apparatus (100b) may be incorporated in the same housing, or may be independent from each other, without being incorporated in the same housing.

### DESCRIPTION OF REFERENCE SIGNS

10 . . . game apparatus, 20 . . . conveyor device for game apparatus, 30 . . . feedback conveyor, 100a, 100b, 100c, 100d . . . station, 110a . . . game field, 120a . . . ball number lottery portion, 130a . . . marble chance execution portion, 140a . . . marble-JP chance execution portion, 150a . . . JP payout portion, 160a . . . control panel, 170a . . . screw lifter, 180a . . . air lifter.

What is claimed is:

1. A conveyor device comprising:
a supporter configured to support a three-dimensional game object, wherein the supporter is rotatable about a rotation axis having a first end and a second end, the supporter extending from the first end to the second end in a helical manner relative to the rotation axis, and wherein the supporter includes a first portion on the first end of the rotation axis, a second portion on the second end of the rotation axis, and a third portion between the first portion and the second portion;
an encircling member that encircles at least the third portion of the supporter; and
at least one guide for the three-dimensional game object to move from the first end to the second end along with the rotation of the supporter, wherein the at least one guide is configured such that the guide in coordination with the supporter and the encircling member supports the three-dimensional game object when the three-dimensional game object moves from the first end to the second end, and wherein the at least one guide extends from the first end to the second end within a gap between the supporter and the encircling member.

2. The conveyor device according to claim 1, wherein:
the encircling member is configured to not encircle the second portion, and
the supporter is configured to discharge the three-dimensional game object through the second portion.

3. The conveyor device according to claim 2, wherein a part of the second portion is provided with an ejection portion configured to eject the three-dimensional game object.

4. A conveyor device comprising:
a supporter configured to support a three-dimensional game object, wherein the supporter is rotatable about a rotation axis having a first end and a second end, the supporter extending from the first end to the second end in a helical manner relative to the rotation axis, and wherein the supporter includes a first portion on the first end of the rotation axis, a second portion on the second end, and a third portion between the first portion and the second portion;
an encircling member that encircles at least the third portion of the supporter; and
at least one guide for the three-dimensional game object to move from the first end to the second end along with the rotation of the supporter, wherein the at least one guide is configured such that the guide in coordination with the supporter and the encircling member supports the three-dimensional game object when the three-dimensional game object moves from the first end to the second end, and wherein the at least one guide extends from the first end to the second end within a gap between the supporter and the encircling member,
wherein
the encircling member is configured to not encircle the first portion, and the supporter is configured to take in the three-dimensional game object through the first portion.

5. The conveyor device according to claim 4, wherein the guide has a portion on the first end of the rotation axis, with the portion configured to be not encircled by the encircling member, and the guide is configured to serve as a guide for the three-dimensional game object to be taken in.

6. The conveyor device according to claim 4, further comprising a supply portion configured to supply to the first portion a three-dimensional game object present near the first portion.

7. The conveyor device according to claim 6, wherein:
the three-dimensional game object is rollable regardless of orientation of the game object, and
the supply portion includes a slope that is at an angle that allows the three-dimensional game object present near the first portion to roll toward the first portion.

8. The conveyor device according to claim 6, wherein the supply portion is configured to supply to the first portion three-dimensional game objects respectively collected from a plurality of game unit portions each configured to use the three-dimensional game object.

9. The conveyor device according to claim 4, wherein:
the encircling member is configured to not encircle the second portion, and
the supporter is configured to discharge the three-dimensional game object through the second portion.

10. The conveyor device according to claim 9, wherein a part of the second portion is provided with an ejection portion configured to eject the three-dimensional game object.
